(19) United States
(12) Patent Application Publication
(10) Pub. No.: US 2012/0302697 A1
(43) Pub. Date: Nov. 29, 2012

(54) COATING COMPOSITION, COATED ARTICLE, AND PROCESS FOR FORMATION OF MULTILAYER COATING FILM

(76) Inventors: Yuichi Inada, Hiratsuka-shi (JP); Mitsuru Kondoh, Hiratsuka-shi (JP); Genji Imai, Hiratsuka-shi (JP); Junpei Hashimoto, Hiratsuka-shi (JP); Masaharu Ishiguro, Hiratsuka-shi (JP); Yasuhiro Tomizaki, Hiratsuka-shi (JP)

(21) Appl. No.: 13/512,088

(22) PCT Filed: Sep. 15, 2010
(86) PCT No.: PCT/JP2010/065964

§ 371 Date: May 25, 2012

(30) Foreign Application Priority Data
Nov. 25, 2009 (JP) 2009-267786
Dec. 23, 2009 (JP) 2009-291578

(51) Int. Cl. C09D 133/12; B05D 3/06

(52) U.S. Cl. 524/561; 522/183; 427/487

(57) ABSTRACT

The problem to be solved by the present invention is to provide a coating composition that can reduce the heating temperature and shorten the heating time in the coating process, and that has excellent scratch resistance and weather resistance. The present invention provides a coating composition comprising a radically polymerizable unsaturated group-containing compound (A) and a hydroxyl-containing resin (B), the compound (A) being obtained by reacting a caprolactone-modified hydroxyalkyl (meth)acrylate with a polyisocyanate compound, and having an isocyanate equivalent of 300 to 3,800.

### TECHNICAL FIELD

The present invention relates to a coating composition, a coated article, and a method for forming a multilayer coating film.

### BACKGROUND ART

On bodies of motorcycles, automobiles, container tracks, and other vehicles, clear coating films are formed after electrodeposition coating films, intermediate coating films, and base coating films are formed, as required. Clear coating films are generally formed by a method for forming a coating film, the method comprising applying a thermosetting coating composition comprising a thermosetting functional group-containing resin (e.g., hydroxyl-containing acrylic resin) and a crosslinking agent (e.g., melamine resin), a thermosetting coating composition comprising an acid-containing resin and an epoxy-containing resin, etc., followed by heat curing. This method can form a coating film having excellent film properties, such as adhesion and film hardness.

Recently, there is a demand for energy saving and higher productivity in coating processes. Along with this demand, there is an expectation for coating compositions that can be cured at low temperatures, and coating compositions that can be cured in a short period of time. However, the above-mentioned thermosetting coating compositions generally require a heating temperature of about 140° C., and a heating time of about 20 to 40 minutes in a general coating process. Thus, those thermosetting coating compositions do not satisfy the requirements for energy saving and higher productivity.

To shorten the heating time, PLT 1 discloses an ultraviolet-curable and thermosetting coating composition comprising an ultraviolet-curable polyfunctional (meth)acrylate, a polyhydric alcohol mono(meth)acrylate polymer, and a polyisocyanate compound. PLT 1 also discloses a method for forming a coating film by applying the coating composition to a substrate, and then performing ultraviolet irradiation, followed by heat curing for about 30 minutes. However, this invention was not able to shorten the heating time, and was not satisfactory in terms of scratch resistance.

PLT 2 discloses a coating composition comprising urethane (meth)acrylate containing a (meth)acryloyl group and a free isocyanate group, optionally a polyisocyanate other than the above urethane (meth)acrylate, an ultraviolet light initiator for initiating radical polymerization, and an isocyanate-reactive group-containing compound. PLT 2 also discloses a method for forming a coating film, comprising applying the coating composition to a substrate, curing the coating composition by polymerization by UV irradiation, and then reaction of the NCO group with the isocyanate-reactive group. This invention allows rapid ultraviolet curing, and provides sufficient curing for non-irradiated areas and less-irradiated areas. However, this invention was not satisfactory in terms of scratch resistance and weather resistance.

PLT 3 discloses a method for forming a multilayer coating film, the method comprising applying a base coating composition to a substrate to form a base coating film, then applying a clear coating composition by a wet-on-wet process to form a clear coating film, and irradiating the clear coating film with high-energy radiation before baking or curing both films at the same time. The method for forming a multilayer coating film is characterized by that the clear coating composition comprises a thermally curable component and a radically polymerizable double bond-containing component, and that the thermally curable component does not substantially contain a radically polymerizable double bond. This invention has an advantage that the clear coating composition has a simple formation and can be made of known components. However, this invention was not able to reduce the heating temperature, and was not satisfactory in terms of scratch resistance.

PLT 4 discloses a coating composition comprising a compound obtained by reacting a compound having three isocyanate groups per molecule with a compound having one hydroxyl group and one or more (meth)acryloyl groups per molecule so that the ratio of the total number of hydroxyl groups to the total number of isocyanate groups is less than 1, an acrylic copolymer having a glass transition temperature of −50 to 0° C. and a hydroxyl value of 50 to 350 mg KOH/g, and a radical polymerization initiator. However, this invention was not satisfactory in terms of weather resistance and scratch resistance.

### CITATION LIST

### Patent Literature

PLT 1: Japanese Unexamined Patent Publication No. 63-113085
PLT 2: Japanese Unexamined Patent Publication No. 11-263939
PLT 3: Japanese Unexamined Patent Publication No. 2001-524868
PLT 4: Japanese Unexamined Patent Publication No. 2008-208205

### SUMMARY OF INVENTION

### Technical Problem

The present invention was made in view of the above-described circumstances. An object of the present invention is to provide a coating composition that can reduce the heating temperature and shorten the heating time in the coating process, and produce a coating film having excellent scratch resistance and weather resistance; and also provide a method for forming a multilayer coating film.

### Solution to Problem

The present inventors conducted extensive research to solve the above problems, and found, as a result, that the problems can be solved by using a coating composition comprising a specific radically polymerizable unsaturated group-containing compound and hydroxyl-containing resin. The present inventors also found that a multilayer coating film having excellent adhesion and finished appearance can be obtained by a method for forming a multilayer coating film, the method comprising forming a base coating film by applying the above coating composition to a substrate, then forming a clear coating film by applying a specific clear coating composition, and performing irradiation with active energy rays and heating. The present invention has thus been accomplished.

More specifically, the present invention provides the following items:

Item 1. A coating composition comprising:

a radically polymerizable unsaturated group-containing compound (A); and

a hydroxyl-containing resin (B);

the compound (A) being obtained by reacting a caprolactone-modified hydroxyalkyl (meth)acrylate with a polyisocyanate compound, and having an isocyanate equivalent of 300 to 3,800.

Item 2. The coating composition according to Item 1, further comprising a photopolymerization initiator (C).
Item 3. The coating composition according to Item 1 or 2, wherein the hydroxyl-containing resin (B) is a hydroxyl-containing acrylic resin.
Item 4. The coating composition according to any one of Items 1 to 3, further comprising an isocyanate compound (D) other than the compound (A).
Item 5. The coating composition according to any one of Items 1 to 4, further comprising a radically polymerizable unsaturated group-containing compound (E) other than the compound (A).
Item 6. The coating composition according to any one of Items 1 to 5, wherein the compound (A) has a weight average molecular weight of 500 to 2,000.
Item 7. The coating composition according to any one of Items 1 to 6, wherein the hydroxyl-containing resin (B) has a glass transition temperature of 0° C. or more.
Item 8. A coated article obtained by applying the coating composition according to any one of Items 1 to 7.
Item 9. A method for forming a multilayer coating film, comprising the steps of:

forming a base coating film by applying a base coating composition comprising an active hydrogen-containing resin and a color pigment to a substrate;

forming a clear coating film by applying the coating composition according to any one of Items 1 to 7; and

performing active energy ray irradiation and heating.

### Advantageous Effects of Invention

The present invention can reduce the heating temperature and shorten the heating time in the coating process, and can produce a coating composition that can form a coating film having excellent scratch resistance and weather resistance. In addition, a multilayer coating film having excellent adhesion and finished appearance can be obtained by a method for forming a multilayer coating film, the method comprising applying the above coating composition to a substrate to form a base coating film, then applying a specific clear coating composition to form a clear coating film, and performing irradiation with active energy rays and heating.

### DESCRIPTION OF EMBODIMENTS

### Coating Composition of the Present Invention

The coating composition of the present invention comprises a radically polymerizable unsaturated group-containing compound (A) (hereinafter sometimes simply referred to as “the compound (A)”) and a hydroxyl-containing Resin (B), the compound (A) being obtained by reacting caprolactone-modified hydroxyalkyl (meth)acrylate with a polyisocyanate compound, and having an isocyanate equivalent of 300 to 3,800.

### Compound (A)

The compound (A) is obtained by reacting caprolactone-modified hydroxyalkyl (meth)acrylate with a polyisocyanate compound, and has an isocyanate equivalent of 300 to 3,800. The compound (A) has excellent curability upon irradiation with active energy rays, and also has excellent curability at low temperatures (specifically, room temperature to 100° C.). These properties of the compound (A) can reduce the heating temperature and shorten the heating time in the coating process. In addition, the coating film obtained from the coating composition of the present invention comprising the compound (A) has excellent scratch resistance and weather resistance.

Caprolactone-modified hydroxyalkyl (meth)acrylate is a compound represented by Formula (I) below:

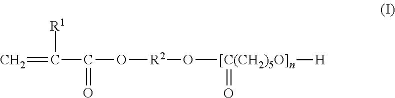

wherein R¹ is hydrogen or methyl, R² is C₂₋₆ alkylene, and n is 1 to 5.

Specific examples of the caprolactone-modified hydroxyalkyl (meth)acrylate include “PLACCEL FA-1,” “PLACCEL FA-2,” “PLACCEL FA-2D,” “PLACCEL FA-3,” “PLACCEL FA-4,” “PLACCEL FA-5,” “PLACCEL FM-1,” “PLACCEL FM-2,” “PLACCEL FM-2D,” “PLACCEL FM-3,” “PLACCEL FM-4,” and “PLACCEL FM-5” (trade names, products of Daicel Chemical Industries, Ltd.). Among these, the caprolactone-modified hydroxyethyl acrylate of Formula (I), wherein R¹ is hydrogen and R² is ethylene, is preferred in terms of active energy ray curability. Similarly, in terms of active energy ray curability, the caprolactone-modified hydroxyethyl acrylate of Formula (I), wherein n is 1 to 3, is preferred.

Polyisocyanate compounds are compounds having at least two isocyanate groups per molecule. Examples of such compounds include aliphatic polyisocyanate compounds, such as hexamethylene diisocyanate, trimethylhexamethylene diisocyanate, dimer acid diisocyanate, and lysine diisocyanate; biuret adducts and isocyanurate ring adducts of such polyisocyanates; alicyclic diisocyanate compounds, such as isophorone diisocyanate, 4,4′-methylenebis(cyclohexylisocyanate), methylcyclohexane-2,4-diisocyanate, methylcyclohexane-2,6-diisocyanate, 1,3-di(isocyanatomethyl)cyclohexane, 1,4-di(isocyanatomethyl)cyclohexane, 1,4-cyclohexane diisocyanate, 1,3-cyclopentane diisocyanate, and 1,2-cyclohexane diisocyanate; biuret adducts and isocyanurate ring adducts of such polyisocyanates; aromatic diisocyanate compounds, such as xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenylether diisocyanate, m-phenylene diisocyanate, p-phenylene diisocyanate, 4,4′-biphenylene diisocyanate, 3,3′-dimethyl-4,4′-biphenylene diisocyanate, bis(4-isocyanatophenyl)sulfone, and isopropylidene bis(4-phenylisocyanate); biuret adducts and isocyanuric ring adducts of such polyisocyanates; polyisocyanate compounds having at least three isocyanate groups per molecule, such as triphenylmethane-4,4′,4″-triisocyanate, 1,3,5-triisocyanatobenzene, 2,4,6-triisocyanatotoluene, and 4,4′-dimethyldiphenylmethane-2,2′,5,5′-tetraisocyanate; biuret adducts and isocyanurate ring adducts of such polyisocyanates; urethanized adducts obtained by reacting a polyol, such as ethylene glycol, propylene glycol, 1,4-butylene glycol, dimethylolpropionic acid, polyalkylene glycol, trimethylol propane, or hexanetriol, with a polyisocyanate compound in a ratio such that the amount of isocyanate groups is excessive relative to the amount of polyol hydroxyl groups; biuret adducts and isocyanurate ring adducts of such polyisocyanates; and the like. These can be used singly or as a mixture of two or more. Among these, in terms of the weather resistance of the coating film, isocyanurate ring adducts of aliphatic polyisocyanate compounds are preferred, and isocyanurate ring adducts of hexamethylene diisocyanates are particularly preferred.

The reaction of the caprolactone-modified hydroxyalkyl (meth)acrylate and a polyisocyanate compound can be carried out by a known method of reacting a hydroxyl-containing compound and a polyisocyanate compound.

The above reaction can generally be carried out in an organic solution. Examples of organic solvents include aromatic hydrocarbon solvents, such as toluene and xylene; ketone solvents, such as acetone, methyl ethyl ketone, methyl isobutyl ketone, and cyclohexanone; ester solvents, such as ethyl acetate, propyl acetate, isobutyl acetate, and butyl acetate; and the like. These can be used singly or as a mixture of two or more.

The reaction temperature is preferably room temperature to 100° C., and the reaction time is preferably 1 to 10 hours.

In the above reaction, dibutyltin dilaurate, dibutyltin diethylhexoate, dibutyltin sulphite, and other catalysts may be used, if necessary. The amount of catalyst is preferably 0.01 to 1 part by mass, and more preferably 0.1 to 0.5 parts by mass, based on 100 parts by mass of the total of the reaction materials. Further, a polymerization inhibitor, such as hydroquinone monomethyl ether, may be used. The amount of polymerization inhibitor is preferably 0.01 to 1 part by mass based on 100 parts by mass of the total of the reaction materials.

Since the compound (A) has isocyanate groups, the mixing ratio of the caprolactone-modified hydroxyalkyl (meth)acrylate and the polyisocyanate compound in the reaction of these compounds is generally such that the equivalent ratio of isocyanate groups of the polyisocyanate compound to hydroxyl groups of the caprolactone-modified hydroxyalkyl (meth)acrylate is in excess (isocyanate groups/hydroxyl groups>1.0). Further, the isocyanate equivalent of the compound (A) can be controlled by adjusting the mixing ratio.

The compound (A) has an isocyanate equivalent of 300 to 3,800. In terms of the scratch resistance of the coating film, the compound (A) preferably has an isocyanate equivalent of 500 to 2,500. The coating composition of the present invention has excellent low-temperature curability, because the compound (A) has isocyanate groups. Moreover, the compound (A) is able to react with the hydroxyl-containing resin (B) to form a tough coating film, because the compound (A) has isocyanate groups.

When the compound (A) is used in a multilayer coating film, the isocyanate equivalent of the compound (A) is preferably 300 to 3,800, and more preferably 500 to 3,000. When the isocyanate equivalent is within the above ranges, the resulting multilayer coating film has excellent scratch resistance, the compound (A) is less likely to soak into the base coating film, and the resulting multilayer coating has excellent adhesion and finished quality. In particular, when the base coating composition is a coating composition comprising a luster pigment, because the compound (A) is less likely to soak into the base coating film, disturbance of the orientation of the luster pigment in the base coating film is prevented, and the resulting multilayer coating film has excellent finished quality.

Here, the isocyanate equivalent used in this specification refers to the molar mass of one isocyanate group.

Assuming that the gram-molecular weight of the compound is M, and the number of isocyanate groups per molecule of the compound is ν, the isocyanate equivalent is expressed as M/ν.

Moreover, the isocyanate equivalent used in this specification is determined by back titration using dibutylamine. The back titration is carried out in such a manner that an excess amount of dibutylamine is reacted with a sample, and the remaining dibutylamine is titrated with an aqueous hydrochloric acid solution using bromophenol blue as a titration indicator.

The compound (A) preferably has an unsaturated equivalent of 300 to 2,000, and more preferably 500 to 1,000. When the unsaturated equivalent is within these ranges, the resulting coating film has more excellent scratch resistance and weather resistance.

Here, the unsaturated equivalent used in this specification refers to the molar mass of one unsaturated group. Assuming that the gram-molecular weight of the compound is M, and the number of unsaturated groups per molecule of the compound is σ, the unsaturated equivalent is expressed as M/σ.

Moreover, the unsaturated equivalent used in this specification is determined by adding dodecyl mercaptan to a radically polymerizable unsaturated group, and back-titrating the remaining dodecyl mercaptan with an iodine solution.

The molecular weight of the compound (A) is not particularly limited. The weight average molecular weight is preferably 500 to 2,000, and more preferably 800 to 1,500. The weight average molecular weight within these ranges is significant in terms of facilitating handling of coating composition viscosity.

Here, the weight average molecular weight used in this specification is determined by converting the retention time (retention volume) measured with a gel permeation chromatograph (“HLC8120GPC,” produced by Tosoh Corporation) using tetrahydrofuran as a solvent, based on the weight average molecular weight of standard polystyrene. The measurement is performed using the four columns “TSKgel G-4000H_{XL},” “TSKgel G-3000H_{XL},” “TSKgel G-2500H_{XL},” and “TSKgel G-2000_{XL},” (trade names of Tosoh Corporation) under the following conditions: mobile phase: tetrahydrofuran; measurement temperature: 40° C.; flow rate: 1 mL/min; and detector: RI.

### Hydroxyl-Containing Resin (B)

The hydroxyl-containing resin (B) is a resin having at least one hydroxyl group per molecule. Examples of the hydroxyl-containing resin (B) include resins having a hydroxyl group, such as polyester resin, acrylic resin, polyether resin, polycarbonate resin, polyurethane resin, epoxy resin, and alkyd resin. These can be used singly or in combination of two or more. Among these, the hydroxyl-containing resin (B) is preferably a hydroxyl-containing acrylic resin, in terms of the weather resistance of the resulting coating film.

Hydroxyl-containing acrylic resins can generally be produced by copolymerizing a hydroxyl-containing polymerizable unsaturated monomer and another polymerizable unsaturated monomer that is copolymerizable with the hydroxyl-containing polymerizable unsaturated monomer, by a known method, such as solution polymerization in an organic solvent, emulsion polymerization in water, or the like.

Hydroxyl-containing polymerizable unsaturated monomers are compounds having at least one hydroxyl group and at least one polymerizable unsaturated bond per molecule. Specific examples thereof include monoesterified products of (meth)acrylic acid with a dihydric alcohol having 2 to 8 carbon atoms (e.g., 2-hydroxyethyl (meth)acrylate, 2-hydroxypropyl (meth)acrylate, 3-hydroxypropyl (meth)acrylate, and 4-hydroxybutyl (meth)acrylate); ε-caprolactone-modified products of the monoesterified products of (meth)acrylic acid with a dihydric alcohol having 2 to 8 carbon atoms; N-hydroxymethyl (meth)acrylamide; allyl alcohol; (meth)acrylates having hydroxy-terminated polyoxyethylene chains; etc.

Examples of other polymerizable unsaturated monomers copolymerizable with the hydroxyl-containing polymerizable unsaturated monomer include alkyl or cycloalkyl (meth)acrylates, such as methyl (meth)acrylate, ethyl (meth)acrylate, n-propyl (meth)acrylate, i-propyl (meth)acrylate, n-butyl (meth)acrylate, i-butyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, “Isostearyl Acrylate” (trade name of Osaka Organic Chemical Industry, Ltd.), cyclohexyl (meth)acrylate, methylcyclohexyl (meth)acrylate, t-butylcyclohexyl (meth)acrylate, and cyclododecyl (meth)acrylate; isobornyl-containing polymerizable unsaturated monomers, such as isobornyl (meth)acrylate; adamanthyl-containing polymerizable unsaturated monomers, such as adamanthyl (meth)acrylate; vinyl aromatic compounds, such as styrene, α-methyl styrene, and vinyltoluene; alkoxysilyl-containing polymerizable unsaturated monomers, such as vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane; perfluoroalkyl (meth)acrylates, such as perfluorobutylethyl (meth)acrylate and perfluorooctylethyl (meth)acrylate; fluorinated alkyl-containing polymerizable unsaturated monomers, such as fluoroolefins; polymerizable unsaturated monomers having photopolymerizable functional groups, such as a maleimide group; vinyl compounds, such as N-vinylpyrrolidone, ethylene, butadiene, chloroprene, vinyl propionate, and vinyl acetate; carboxy-containing polymerizable unsaturated monomers, such as (meth)acrylic acid, maleic acid, crotonic acid, and β-carboxyethyl acrylate; nitrogen-containing polymerizable unsaturated monomers, such as (meth)acrylonitrile, (meth)acrylamide, N,N-dimethylaminoethyl (meth)acrylate, N,N-dimethylaminopropyl (meth)acrylamide, and adducts of glycidyl (meth)acrylate with amine compounds; polymerizable unsaturated monomers having two or more polymerizable unsaturated groups per molecule, such as allyl (meth)acrylate and 1,6-hexanedioldi(meth)acrylate; epoxy-containing polymerizable unsaturated monomers, such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether; (meth)acrylate having alkoxy-terminated polyoxyethylene chains; sulfonic acid group-containing polymerizable unsaturated monomers, such as 2-acrylamide-2-methylpropanesulfonic acid, allylsulfonic acid, styrenesulfonic acid, and sulfoethyl methacrylate, including sodium salts and ammonium salts of these sulfonic acid group-containing polymerizable unsaturated monomers; phosphoric acid group-containing polymerizable unsaturated monomers, such as 2-acryloyloxyethyl acid phosphate, 2-methacryloiloxyethyl acid phosphate, 2-acryloyloxypropyl acid phosphate, and 2-methacryloyloxypropyl acid phosphate; polymerizable unsaturated monomers having UV-absorbing functional groups, such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-(2′-hydroxy-5′-methacryloiloxyethylphenyl)-2H-benzotriazole; UV-stable polymerizable unsaturated monomers, such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine; carbonyl-containing polymerizable unsaturated monomers, such as acrolein, diacetone acrylamide, diacetone methacrylamide, acetoacetoxylethyl methacrylate, formylstyrol, and vinyl alkyl ketones having 4 to 7 carbon atoms (e.g., vinyl methyl ketone, vinyl ethyl ketone, and vinyl butyl ketone); and the like. These can be used singly or in combination of two or more.

The hydroxyl-containing resin (B) generally has a hydroxyl value of 30 to 300 mg KOH/g, preferably 40 to 250 mg KOH/g, and more preferably 50 to 200 mg KOH/g, in terms of low-temperature curability and the water resistance of the resulting coating film.

The hydroxyl-containing resin (B) preferably has an acid group, such as a carboxyl group, from the viewpoint of increasing the reactivity with the compound (A).

The hydroxyl-containing resin (B) preferably has an acid value of 1 to 25 mg KOH/g, and more preferably 1 to 20 mg KOH/g.

The hydroxyl-containing resin (B) generally has a weight average molecular weight of 3,000 to 100,000, preferably 4,000 to 50,000, and more preferably 5,000 to 30,000.

The hydroxyl-containing resin (B) preferably has a glass transition temperature of 0° C. or more, and particularly preferably 3 to 50° C., in terms of scratch resistance and weather resistance.

The glass transition temperature (° C.) as used herein refers to the static glass transition temperature. For example, using a differential scanning calorimeter (“DSC-50Q”, trade name of Shimadzu Corp.), a sample is taken in a measuring cup and subjected to vacuum suction, and the solvent is completely removed. Heat changes are measured at a heating rate of 3° C./rain in a temperature range of −100° C. to 100° C. The initial change point in the baseline at the low temperature side is considered to be the glass transition temperature.

### Photopolymerization Initiator (C)

The coating composition of the present invention may further comprise a photopolymerization initiator (C).

As the photopolymerization initiator, any initiator can be used without limitation, as long as it can absorb active energy rays and generate radicals.

Examples of the photopolymerization initiator include α-diketone compounds, such as benzyl and diacetyl; acyloin compounds, such as benzoin; acyloin ether compounds, such as benzoin methyl ether, benzoin ethyl ether, and benzoin isopropyl ether; thioxanthone compounds, such as thioxanthone, 2,4-diethylthioxanthone, 2-isopropylthioxanthone, and thioxanthone-4-sulfonic acid; benzophenone compounds, such as benzophenone, 4,4′-bis(dimethylamino)benzophenone, and 4,4′-bis(diethylamino)benzophenone; Michler's ketone compounds; acetophenone compounds, such as acetophenone, 2-(4-toluenesulfonyloxy)-2-phenylacetophenone, p-dimethylaminoacetophenone, α,α′-dimethoxyacetoxybenzophenone, 2,2′-dimethoxy-2-phenylacetophenone, p-methoxyacetophenone, 2-methyl[4-(methylthio)phenyl]-2-morpholino-1-propanone, 2-benzyl-2-dimethylamino-1-(4-morpholinophenyl)-butan-1-one, α-isohydroxy isobutylphenone, α,α′-dichloro-4-phenoxyacetophenone, and 1-hydroxy-cyclohexyl-phenylketone; acylphosphine oxide compounds, such as 2,4,6-trimethylbenzoyldiphenylphosphine oxide and bis(acyl)phosphine oxide; quinones, such as anthraquinone and 1,4-naphthoquinone; halogenated compounds, such as phenacyl chloride, trihalomethylphenylsulfone, and tris(trihalomethyl)-s-triazine; peroxides, such as di-t-butyl peroxide; and the like. These can be used singly or as a mixture of two or more.

Commercially available photopolymerization initiators include, for example, Irgacure 184, Irgacure 261, Irgacure 500, Irgacure 651, Irgacure 907, and Irgacure CGI 1700 (trade names of Ciba Specialty Chemicals); Darocur 1173, Darocur 1116, Darocur 2959, Darocur 1664, and Darocur 4043 (trade names of Merck Japan); Kayacure MBP, Kayacure DETX-S, Kayacure DMBI, Kayacure EPA, and Kayacure OA (trade names of Nippon Kayaku Co., Ltd.); Vicure 10 and Vicure 55 (trade names of Stauffer Co., Ltd.); Trigonal P1 (trade name of Akzo Co., Ltd.); Sandoray 1000 (trade name of Sandoz Co., Ltd.); DEAP (trade name of Apjohn Co., Ltd.); Quantacure PDO, Quantacure ITX, and Quantacure EPD (trade names of Ward Blenkinsop & Co., Ltd.); and the like.

### Isocyanate Compound (D)

The coating composition of the present invention may further comprise an isocyanate compound (D) other than the compound (A).

The isocyanate compound (D) is a compound having an isocyanate group per molecule. Examples thereof include polyisocyanate compounds listed in the explanation of the compound (A) above. Among those polyisocyanate compounds, in terms of the weather resistance of the coating film, isocyanurate ring adducts of aliphatic polyisocyanate compounds are preferred, and isocyanurate ring adducts of hexamethylene diisocyanates are particularly preferred.

### Radically Polymerizable Unsaturated Group-Containing Compound (E)

The coating composition of the present invention may further comprise a radically polymerizable unsaturated group-containing compound (E) other than the compound (A).

Examples of the radically polymerizable unsaturated group-containing compound (E) include monofunctional radically polymerizable unsaturated group-containing compounds and polyfunctional radically polymerizable unsaturated group-containing compounds.

Monofunctional radically polymerizable unsaturated group-containing compounds are, for example, esterified products of (meth)acrylic acid with a monohydric alcohol. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, neopentyl (meth)acrylate, cyclohexyl (meth)acrylate, tetrahydrofurfuryl (meth)acrylate, isobornyl (meth)acrylate, phenyl (meth)acrylate, benzyl (meth)acrylate, N-acryloyloxyethyl hexahydrophthalimide, etc.

Other examples are hydroxyl-containing (meth)acrylates, such as hydroxyethyl (meth)acrylate, hydroxypropyl (meth)acrylate, and hydroxybutyl (meth)acrylate; carboxyl group-containing (meth)acrylates, such as acrylic acid, methacrylic acid, crotonic acid, itaconic acid, maleic acid, fumaric acid, 2-carboxyethyl (meth)acrylate, 2-carboxypropyl (meth)acrylate, and 5-carboxypentyl (meth)acrylate; glycidyl group-containing radically polymerizable unsaturated group-containing compounds, such as glycidyl (meth)acrylate and allyl glycidyl ether; vinyl aromatic compounds, such as styrene, α-methylstyrene, vinyltoluene, and α-chlorostyrene; nitrogen-containing alkyl (meth)acrylates, such as N,N-dimethylaminoethyl (meth)acrylate, N,N-diethylaminoethyl (meth)acrylate, and N-t-butylaminoethyl (meth)acrylate; polymerizable amide compounds, such as acrylamide, methacrylamide, N-methyl (meth)acrylamide, N-ethyl (meth)acrylamide, N-methylol (meth)acrylamide, N-methoxymethyl (meth)acrylamide, N-butoxymethyl (meth)acrylamide, N,N-dimethyl (meth)acrylamide, N,N-dimethylaminopropyl (meth)acrylamide, N,N-dimethylaminoethyl (meth)acrylamide; and the like.

Polyfunctional radically polymerizable unsaturated group-containing compounds are, for example, esterified products of (meth)acrylic acid with a polyhydric alcohol. Specific examples thereof include di(meth)acrylate compounds, such as ethylene glycol di(meth)acrylate, diethylene glycol di(meth)acrylate, triethylene glycol di(meth)acrylate, tetraethylene glycol di(meth)acrylate, 1,3-butanediol di(meth)acrylate, 1,4-butanediol di(meth)acrylate, 1,9-nonanediol di(meth)acrylate, glycerin di(meth)acrylate, trimethylol propane di(meth)acrylate, pentaerythritol di(meth)acrylate, neopentyl glycol di(meth)acrylate, 1,6-hexanediol di(meth)acrylate, pentaerythritol di(meth)acrylate, and bisphenol A ethylene oxide-modified di(meth)acrylate; tri(meth)acrylate compounds, such as glycerin tri(meth)acrylate, trimethylolpropane tri(meth)acrylate, trimethylolpropane propylene oxide-modified tri(meth)acrylate, trimethylolpropane ethylene oxide-modified tri(meth)acrylate, pentaerythritol tri(meth)acrylate, and ε-caprolactone-modified tris(acryloxyethyl)isocyanurate; tetra(meth)acrylate compounds, such as pentaerythritol tetra(meth)acrylate; dipentaerythritol penta(meth)acrylate, dipentaerythritol hexa(meth)acrylate, etc. Other examples are urethane (meth)acrylate resins, epoxy (meth)acrylate resins, polyester (meth)acrylate resins, etc. Urethane (meth)acrylate resins can be obtained by, for example, using a polyisocyanate compound, a hydroxylalkyl (meth)acrylate, and a polyol compound as starting materials, and reacting them so that the amount of hydroxyl groups is equimolar to or in excess of the amount of isocyanate groups. These radically polymerizable unsaturated group-containing compounds can be used singly or in combination of two or more.

In terms of the scratch resistance of the coating film, examples of the radically polymerizable unsaturated group-containing compound (E) preferably include tri- or higher-functional radically polymerizable unsaturated group-containing compounds.

In terms of low-temperature curability, examples of the radically polymerizable unsaturated group-containing compound preferably include hydroxyl-containing radically polymerizable unsaturated group-containing compounds.

In terms of low-temperature curability and the scratch resistance of the coating film, the radically polymerizable unsaturated group-containing compound (E) preferably has an unsaturated equivalent of 100 to 1,500, and more preferably 150 to 1,000.

As the radically polymerizable unsaturated group-containing compound (E), it is preferable to use a urethane acrylate compound in terms of scratch resistance, and an aliphatic urethane acrylate compound in terms of weather resistance.

Although the content of each of the above components in the coating composition of the present invention is not particularly limited, the following content ranges are preferable in terms of film performance, described later.

The compound (A) content is preferably 1 to 70 parts by mass, and more preferably 10 to 40 parts by mass, based on 100 parts by mass of nonvolatile components in the coating composition of the present invention. These ranges are significant in terms of scratch resistance and weather resistance.

The hydroxyl-containing resin (B) content is preferably 1 to 70 parts by mass, and more preferably 10 to 60 parts by mass, based on 100 parts by mass of nonvolatile components in the coating composition of the present invention. These ranges are significant in terms of low-temperature curability.

The photopolymerization initiator (C) content is preferably 1 to 8 parts by mass, and more preferably 2 to 6 parts by mass, based on 100 parts by mass of nonvolatile components in the coating composition of the present invention. These ranges are significant in terms of the reactivity to active energy rays.

The isocyanate compound (D) content is preferably 5 to 30 parts by mass, and more preferably 10 to 25 parts by mass, based on 100 parts by mass of nonvolatile components in the coating composition of the present invention. These ranges are significant in terms of low-temperature curability.

The radically polymerizable unsaturated group-containing compound (E) content is preferably 1 to 50 parts by mass, and more preferably 5 to 40 parts by mass, based on 100 parts by mass of nonvolatile components in the coating composition of the present invention. These ranges are significant in terms of scratch resistance and weather resistance.

The proportion of the compound (A), the hydroxyl-containing resin (B), and the optionally added isocyanate compound (D) is such that the equivalent ratio of the total amount of isocyanate groups of the compound (A) and isocyanates groups of the optionally added isocyanate compound (D) to the amount of hydroxyl groups of the hydroxyl-containing resin (B) (NCO/OH) is preferably in the range of 0.30 to 2.00, and more preferably 0.50 to 1.80. These ranges are significant in terms of the scratch resistance and weather resistance of the coating film.

When the coating composition comprises the isocyanate compound (D), the proportion of the compound (A) and the isocyanate compound (D) is such that the equivalent ratio of isocyanate groups of the compound (A) to isocyanate groups of the isocyanate compound (D) (NCO of the compound (A)/NCO of the isocyanate compound (D)) is preferably in the range of 0.10 to 9.00, preferably 0.20 to 4.00. These ranges are significant in terms of the acid resistance of the coating film.

The coating composition of the present invention may further contain, if necessary, common additives for coating compositions, such as curing catalysts, thickeners, UV absorbers, light stabilizers, defoaming agents, antirust agents, plasticizers, organic solvents, surface control agents, and antisettling agents, which can be used singly or in combination of two or more.

Although the coating composition of the present invention may be either an organic solvent-based coating composition or an aqueous coating composition, an organic solvent-based coating composition is preferable from the viewpoint of storage stability, etc. In this specification, aqueous coating compositions refer to coating compositions that contain water as a main component of the solvent; and organic solvent-based coating compositions refer to coating compositions that do not substantially contain water as the solvent.

The organic solvent to be used in organic solvent-type coating compositions is not particularly limited. Specific examples thereof include ketone-based solvents, such as acetone, methyl ethyl ketone, methyl isobutyl ketone, cyclohexanone, methyl amyl ketone, ethyl isoamyl ketone, diisobutyl ketone, and methyl hexyl ketone; ester-based solvents, such as ethyl acetate, butyl acetate, methyl benzoate, and methyl propionate; ether-based solvents, such as tetrahydrofuran, dioxane, and dimethoxyethane; glycol ether-based solvents, such as propylene glycol monomethyl ether acetate and 3-methoxybutyl acetate; aromatic hydrocarbon-based solvents, aliphatic hydrocarbon-based solvents, etc.

### Method for Forming a Coating Film

The present invention provides a method for forming a coating film using the above coating composition.

### Substrate

The substrate to be coated with the coating composition of the present invention is not particularly limited. Examples of usable substrates include metallic materials, such as iron, aluminum, brass, copper, stainless steel, tin plate, galvanized steel, and steels plated with zinc alloy (Zn—Al, Zn—Ni, Zn—Fe, etc.); plastic materials, such as polyethylene resin, polypropylene resin, polymethyl methacrylate resin, acrylonitrile-butadiene-styrene (ABS) resin, polyamide resin, acryl resin, vinylidene chloride resin, polycarbonate resin, polyurethane resin, epoxy resin, and like resins, and various types of FRP; inorganic materials, such as glass, cement, and concrete; wood; textile materials (paper, cloth, etc.); and the like. Among these, metallic materials and plastic materials are particularly preferable.

Use of the substrate to be coated with the coating composition of the present invention is not particularly limited. For example, the substrate is used for exterior body panels of vehicles, such as cars, trucks, motorbikes, and buses; automobile parts; exterior panels of home electric appliances, such as mobile phones and audio equipment; and the like. Among these, vehicle body exterior panels and automobile parts are preferable.

The substrate may be a metal material as described above or a vehicle body formed from such metal material, whose metal surface has been subjected to a surface treatment, such as phosphate treatment, chromate treatment, zirconium treatment, and composite oxide treatment. The substrate may also be such metal material, vehicle body, or the like as described above, on which an undercoating film of various electrodeposition coating compositions is further formed. The substrate may also be such plastic material as described above, on which a primer coating film is further formed.

The substrate may also be such plastic material as described above, on which an uncured or cured aqueous or organic solvent-type primer coating film is formed, optionally followed by preheating.

Here, in terms of cutting processes and saving energy to reduce the number of times of baking in the hot-air drying furnace and reduce energy consumption, it is preferable that an organic solvent-type primer is used as the above primer coating composition, without preheating, and that an aqueous coating composition is used as the base coating composition to be applied to the primer coating film.

Further, a topcoat base coating film may be formed on the undercoating film or primer coating film, and a topcoat clear coating film may be further formed on the topcoat base coating film. Known coating compositions can be used to form the undercoating film, topcoat base coating film, and topcoat clear coating film. It is preferable to form the base coating film using coating compositions described later in Section “Base coating composition.”

### Application of the Coating Composition of the Present Invention

When applying the coating composition of the present invention, it is preferable to adjust the nonvolatile content to generally 15 mass % or more, particularly 20 to 35 mass %, as well as to adjust the viscosity to 14 to 20 seconds/Ford Cup #4/20° C.

The method of applying the coating composition of the present invention is not particularly limited. For example, the coating composition can be applied by air spraying, airless spraying, rotary atomization coating, dip coating, brushing, or the like. An electrostatic charge may be applied during coating. The coating film thickness (the cured film thickness) is generally 10 to 100 μm, preferably 10 to 50 μm, and more preferably 15 to 35 μm.

After coating, preheating and air blowing can be performed to reduce or remove volatile components of the coating film immediately after coating. Preheating can usually be performed by directly or indirectly heating a coated substrate in a drying furnace at 50 to 110° C., preferably at 60 to 90° C., for 1 to 30 minutes. Air blowing can usually be performed by blowing room temperature air or air heated to 25 to 80° C. over the coated surface of the substrate.

The coating composition of the present invention is generally cured by heating and active energy ray irradiation. The order of performing heating and active energy ray irradiation is not particularly limited; active energy ray irradiation may be performed after heating, heating may be performed after active energy ray irradiation, or heating and active energy ray irradiation may be performed at the same time.

When heating and active energy ray irradiation are performed at the same time, the heat source may be heat generated from the active energy ray irradiation source (e.g., heat generated by a lamp). When active energy ray irradiation is performed after heating, the substrate may be irradiated with active energy rays while the substrate remains warm (namely, while the substrate has remaining heat).

The heating conditions are not particularly limited. For example, heating can be performed at a temperature of 50 to 140° C. for 1 to 60 minutes. Since the coating composition of the present invention has low-temperature curability, the desired performance, such as scratch resistance and weather resistance, can be obtained without heating at high temperature (e.g., 100° C. or more). It is therefore preferable to heat the coating composition of the present invention at a temperature of 50 to 100° C. Moreover, since the coating composition of the present invention is cured by active energy rays, the desired performance, such as scratch resistance and weather resistance, can be obtained without heating for a long time. It is therefore preferable to heat the coating composition of the present invention for 1 to 30 minutes, and more preferably 1 to 20 minutes.

Usable active energy rays are, for example, ultraviolet rays, visible rays, and laser beam (near-infrared rays, visible light laser, ultraviolet laser, etc.). The exposure dose is generally 100 to 5,000 mJ/cm², and preferably 300 to 3,000 mJ/cm². Moreover, examples of sources of active energy rays include lights from conventional light sources, such as extra-high-pressure, high-pressure, medium-pressure, or low-pressure mercury lamps, electrodeless lamps (Fusion UV Systems, Inc.), chemical lamps, carbon arc lamps, xenon lamps, metal halide lamps, fluorescent lights, tungsten lamps and sunlight; lights in the visible region cut by a UV cut filter; various lasers that produce an oscillating beam in the visible region; and the like. Also usable is a pulse-emission type active energy ray irradiation apparatus.

### Method for Forming a Multilayer Coating Film

In a preferred embodiment, the present invention provides a method for forming a multilayer coating film, comprising the steps of forming a base coating film by applying a base coating composition comprising an active hydrogen-containing resin and a color pigment to a substrate, forming a clear coating film by applying the coating composition according to claim 1, and performing active energy ray irradiation and heating.

In this embodiment, usable substrates are those mentioned above in Section “Substrate.”

### Base Coating Composition

The base coating composition comprises an active hydrogen-containing resin and a coloring pigment. Examples of the active hydrogen group of the active hydrogen-containing resin include hydroxyl, hydroxyphenyl, amino, etc. In the present invention, hydroxyl-containing resins are preferable in terms of weather resistance. Examples of hydroxyl-containing resins include hydroxyl-containing acrylic resin, hydroxyl-containing polyester resins, hydroxyl-containing polyurethane resins, hydroxyl-containing polyether resins, etc. Among these, hydroxyl-containing acrylic resins are preferable in terms of weather resistance.

Hydroxyl-containing acrylic resin can be produced by copolymerizing hydroxyl-containing polymerizable unsaturated monomers as mentioned above in Section “Hydroxyl-containing resin (B),” and other polymerizable unsaturated monomers that are copolymerizable with the hydroxyl-containing polymerizable unsaturated monomers, by the above-mentioned method.

When used in the base coating composition, the hydroxyl-containing resin preferably has a hydroxyl value of 0.5 to 200 mg KOH/g. Hydroxyl values outside of this range are not preferable, because adhesion and hardness may decrease at a hydroxyl value of less than 0.5 mg KOH/g, whereas the water resistance of the resulting multilayer coating film may decrease at a hydroxyl value of more than 200 mg KOH/g.

Moreover, when used in the base coating composition, the hydroxyl-containing resin generally has a weight average molecular weight of 1,000 to 200,000, and preferably 2,000 to 100,000.

Furthermore, when used in the base coating composition, the hydroxyl-containing resin preferably has a glass transition temperature of 0° C. or more, and more preferably 3 to 50° C., in terms of weather resistance and scratch resistance.

Examples of coloring pigments include aluminum paste, pearl powder, graphite, MIO, and other luster pigments, titanium white, phthalocyanine blue, carbon black, etc. Extender pigments may be added, if necessary. The amount of coloring pigment is preferably, for example, but not limited to, 1 to 150 parts by mass, and more preferably 1 to 100 parts by mass, based on 100 parts by mass of resin nonvolatile components in the base coating composition.

The base coating composition may contain a curing agent. Usable during agents are generally compounds having a crosslinkable functional group that can react with the active hydrogen group of the active hydrogen-containing resin. Preferable examples of such curing agents include amino resins, polyisocyanate compounds, blocked polyisocyanate compounds, etc. Such curing agents can be used singly or in combination of two or more.

Usable amino resins include, for example, partially or fully methylolated amino resins obtained by reacting aldehyde with amino components, such as melamine, urea, benzoguanamine, acetoguanamine, steroguanamine, spiroguanamine, dicyandiamide, etc. Preferable amino resins are melamine resins.

Commercial products of melamine resins can be used, including “Cymel 202,” “Cymel 203,” “Cymel 238,” “Cymel 251,” “Cymel 303,” “Cymel 323,” “Cymel 324,” “Cymel 325,” “Cymel 327,” “Cymel 350,” “Cymel 385,” “Cymel 1156,” “Cymel 1158,” “Cymel 1116,” and “Cymel 1130” (Japan Cytec Industries, Inc.); “U-Van 120,” “U-Van 20HS,” “U-Van 20SE60,” “U-Van 2021,” “U-Van 2028,” and “U-Van 28-60” (Mitsui Chemicals, Inc.); and the like.

These melamine resins can be used singly or in combination of two or more.

Polyisocyanate compounds are compounds having two or more isocyanate groups per molecule.

The blocked polyisocyanate compound is obtained by adding a blocking agent to isocyanate groups of the above polyisocyanate compounds. The blocked polyisocyanate compounds can react with hydroxyl groups when the blocking agent is dissociated by heating to regenerate isocyanate groups. The dissociation temperature of the blocking agent is generally about 60 to about 140° C., and more preferably about 70 to about 120° C.

In terms of weather resistance, the curing agent content of the base coating composition is preferably 1 to 70 parts by mass, more preferably 1 to 60 parts by mass, and even more preferably 1 to 50 parts by mass, based on 100 parts by mass of the total of the active hydrogen-containing resin and curing agent. The base coating composition may contain, if necessary, additives for coating compositions, such as UV absorbers, light stabilizers, antioxidants, surface control agents, pigment dispersants, and curing catalysts. The base coating composition may be either an organic solvent-based coating composition or an aqueous coating composition. In terms of reducing volatile organic compounds (VOC) in the coating process, the base coating composition is preferably an aqueous coating composition.

### Formation of Base Coating Film

A base coating film is formed by applying the base coating composition to a substrate. When applying the base coating composition, it is preferable to adjust the nonvolatile content to generally 15 mass % or more, and particularly 20 to 35 mass %, as well as to adjust the viscosity to 20 to 40 seconds/Ford Cup #4/20° C.

The coating method is not particularly limited. For example, air spraying, airless spraying, rotary atomization coating, dip coating, brushing, or the like can be used. An electrostatic charge may be applied during coating. The film thickness of the base coating film formed by applying the base coating composition is generally 3 to 30 μm, preferably 7 to 25 μm, and more preferably 10 to 20 μm, based on the cured coating film.

A clear coating composition is applied onto the formed base coating film. The base coating film may be cured or uncured when the clear coating composition is applied thereto. The base coating film is generally cured by heating. The heating conditions are, for example, such that the temperature is 100 to 150° C., and the time is 5 to 30 minutes. When the base coating film is uncured, preheating and air blowing can be performed to reduce or remove volatile components of the base coating film. Preheating can usually be performed by directly or indirectly heating a coated substrate in a drying furnace at 50 to 110° C., preferably at 60 to 90° C., for 1 to 30 minutes. Air blowing can usually be performed by blowing room temperature air or air heated to 25 to 80° C. over the coated surface of the substrate.

### Formation of Clear Coating Film

A clear coating film is formed by applying the above-described coating composition of the present invention to the base coating film.

For the nonvolatile content, the coating method, the conditions of preheating and air blowing, and the method of curing the coating composition, when applying the coating composition of the present invention, the conditions described in Section “Application of the coating composition of the present invention” can be employed.

In this embodiment, the base coating composition may be either a solvent-type coating composition or an aqueous coating composition. Moreover, the base coating film formed from the base coating composition may be cured or uncured before the clear coating composition is applied thereto. However, in terms of reducing volatile organic compounds (VOC) in the coating process, and shortening the coating process, it is preferable that the base coating composition is an aqueous base coating composition, the clear coating composition is applied to form a clear coating film while the base coating film formed from the base coating composition is uncured, and both coating films are cured at the same time (2-coat 1-bake system).

### EXAMPLES

The present invention is described below in more detail with reference to Examples. The “parts” and “%” refer to “parts by mass” and “% by mass,” respectively, unless otherwise stated separately.

### Production of Compound (A)

### Production Example 1

A mixture of 33.8 parts of methoxypropylacetate, 50.0 parts of isocyanurate ring adducts of hexamethylene diisocyanate (NCO content: 21%), 0.02 parts of dibutyltin dilaurate, and 0.2 parts of hydroquinone monomethyl ether was introduced into a reaction vessel equipped with a stirrer, a thermometer, a reflux condenser, and a dropping funnel. The mixture was heated to 50° C. with stirring. Subsequently, 85.2 parts of PLACCEL FA-2D (trade name, produced by Daicel Chemical Industries, Ltd., the caprolactone-modified hydroxyethyl acrylate represented by Formula (I), wherein R¹ is hydrogen, R² is ethylene, and n is 2) was added thereto dropwise over a period of 8 hours while ensuring that the temperature of the mixture did not exceed 60° C., and the resulting mixture was stirred at 60° C. for another 1 hour, thereby obtaining a compound (A-1) solution having a nonvolatile content of 80%. The obtained compound (A-1) had an isocyanate equivalent of 2,731, an unsaturated equivalent of 546, and a weight average molecular weight of 1,366.

### Production Examples 2 to 12

Solutions of compounds (A-2) to (A-7) and solutions of compounds (A′-1) to (A′-5) were obtained as in Production Example 1, except that the amounts of the components were adjusted as shown in Table 1. Table 1 shows the isocyanate equivalents, unsaturated equivalents, and weight average molecular weights of the obtained compounds.

TABLE 1

| | Production Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| | Compound | | | | | | | | | | | |
| | A-1 | A-2 | A-3 | A-4 | A-5 | A-6 | A-7 | A′-1 | A′-2 | A′-3 | A′-4 | A′-5 |
| Methoxypropylacetate | 33.8 | 32.1 | 29.5 | 25.3 | 21.0 | 25.0 | 30.0 | 34.5 | 32.3 | 14.7 | 17.5 | 15.0 |
| Isocyanurate Ring Adduct of | 50.0 | 50.0 | 50.0 | 50.0 | 50.0 | 50.0 | 50.0 | 50.0 | 50.0 | 50.0 | 50.0 | 50.0 |
| Hexamethylene Diisocyanate | | | | | | | | | | | | |
| Dibutyltin Dilaurate | 0.02 | 0.02 | 0.02 | 0.02 | 0.02 | 0.02 | 0.02 | 0.02 | 0.02 | 0.02 | 0.02 | 0.02 |
| Hydroquinone Monomethyl Ether | 0.2 | 0.2 | 0.2 | 0.2 | 0.2 | 0.2 | 0.2 | 0.2 | 0.2 | 0.2 | 0.2 | 0.2 |
| PLACCEL FA-2D | 85.2 | 78.4 | 68.2 | 51.1 | 34.1 | | | 102.3 | 92.0 | 10.2 | | |
| PLACCEL FA-1 (Note 1) | | | | | | 50.1 | | | | | | |
| PLACCEL FM-3 (Note 2) | | | | | | | 70.2 | | | | | |
| Hydroxyethyl Acrylate | | | | | | | | | | | 23.0 | 11.5 |
| Nonvolatile Content (%) | 80 | 80 | 80 | 80 | 80 | 80 | 80 | 80 | 80 | 80 | 80 | 80 |
| Isocyanate Equivalent (Note 3) | 2731 | 1852 | 1193 | 681 | 425 | 1264 | 808 | — | 4782 | 225 | 816 | 350 |
| Unsaturated Equivalent | 546 | 564 | 597 | 681 | 849 | 460 | 808 | 513 | 531 | 2026 | 408 | 700 |
| Weight Average Molecular Weight | 1366 | 1297 | 1193 | 1021 | 849 | 1011 | 1213 | 1538 | 1434 | 608 | 816 | 700 |

(Note 1) PLACCEL FA-1: trade name, produced by Daicel Chemical Industries, Ltd., the caprolactone-modified hydroxyethyl acrylate represented by Formula (I), wherein R¹ is hydrogen, R² is ethylene, and n is 1.
(Note 2) PLACCEL FM-3: trade name, produced by Daicel Chemical Industries, Ltd., the caprolactone-modified hydroxyethyl methacrylate represented by Formula (I), wherein R¹ is methyl, R² is ethylene, and n is 3.
(Note 3) “—” indicates that an isocyanate group was not observed.

### Production of Hydroxyl-Containing Resin (B)

### Production Example 13

### Production of Hydroxyl-Containing Acrylic Resin (B-1)

80 parts of xylene was introduced into a reaction vessel equipped with a stirrer, a thermometer, a reflux condenser, and a dropping funnel, and stirred at 100° C. while blowing nitrogen gas thereinto. Then, a mixture of 10 parts of styrene, 40 parts of methyl methacrylate, 8 parts of i-butyl methacrylate, 20 parts of n-butyl acrylate, 20 parts of 2-hydroxyethyl acrylate, 2 parts of acrylic acid, and 4 parts of 2,2′-azobisisobutyronitrile was added thereto dropwise at a constant rate over a period of 3 hours, and the resulting mixture was aged at the same temperature for another 2 hours. Thereafter, a mixture of 10 parts of xylene and 0.5 parts of 2,2′-azobisisobutyronitrile was further added to the reaction vessel dropwise over a period of 1 hour. After completion of the dropwise addition, the resulting mixture was aged for 1 hour, thereby obtaining a hydroxyl-containing acrylic resin (B-1) solution having a nonvolatile content of 55%. The obtained hydroxyl-containing acrylic resin (B-1) had an acid value of 15.6 mg KOH/g, a hydroxyl value of 96.6 mg KOH/g, a weight average molecular weight of 20,000, and a glass transition temperature of 14.6° C.

### Production Example 14

### Production of Hydroxyl-Containing Acrylic Resin (B-2)

80 parts of xylene was introduced into a reaction vessel equipped with a stirrer, a thermometer, a reflux condenser, and a dropping funnel, and stirred at 100° C. while blowing nitrogen gas thereinto. Then, a mixture of 10 parts of styrene, 40 parts of methyl methacrylate, 8 parts of i-butyl methacrylate, 10 parts of n-butyl acrylate, 30 parts of 2-hydroxyethyl acrylate, 2 parts of acrylic acid, and 4 parts of 2,2′-azobisisobutyronitrile was added thereto dropwise at a constant rate over a period of 3 hours, and the resulting mixture was aged at the same temperature for another 2 hours. Thereafter, a mixture of 10 parts of xylene and 0.5 parts of 2,2′-azobisisobutyronitrile was further added to the reaction vessel dropwise over a period of 1 hour. After completion of the dropwise addition, the resulting mixture was aged for 1 hour, thereby obtaining a hydroxyl-containing acrylic resin (B-2) solution having a nonvolatile content of 55%. The obtained hydroxyl-containing acrylic resin (B-2) had an acid value of 15.6 mg KOH/g, a hydroxyl value of 144.9 mg KOH/g, a weight average molecular weight of 20,000, and a glass transition temperature of 13.6° C.

### Production Example 15

### Production of Hydroxyl-Containing Acrylic Resin (B-3)

80 parts of xylene was introduced into a reaction vessel equipped with a stirrer, a thermometer, a reflux condenser, and a dropping funnel, and stirred at 100° C. while blowing nitrogen gas thereinto. Then, a mixture of 10 parts of styrene, 33 parts of methyl methacrylate, 8 parts of i-butyl methacrylate, 27 parts of n-butyl acrylate, 20 parts of 2-hydroxyethyl acrylate, 2 parts of acrylic acid, and 4 parts of 2,2′-azobisisobutyronitrile was added thereto dropwise at a constant rate over a period of 3 hours, and the resulting mixture was aged at the same temperature for another 2 hours. Thereafter, a mixture of 10 parts of xylene and 0.5 parts of 2,2′-azobisisobutyronitrile was further added to the reaction vessel dropwise over a period of 1 hour. After completion of the dropwise addition, the resulting mixture was aged for 1 hour, thereby obtaining a hydroxyl-containing acrylic resin (B-3) solution having a nonvolatile content of 55%. The obtained hydroxyl-containing acrylic resin (B-3) had an acid value of 15.6 mg KOH/g, a hydroxyl value of 96.6 mg KOH/g, a weight average molecular weight of 20,000, and a glass transition temperature of 3.9° C.

### Production Example 16

### Production of Hydroxyl-Containing Acrylic Resin (B-4)

80 parts of xylene was introduced into a reaction vessel equipped with a stirrer, a thermometer, a reflux condenser, and a dropping funnel, and stirred at 100° C. while blowing nitrogen gas thereinto. Then, a mixture of 20 parts of styrene, 40 parts of methyl methacrylate, 18 parts of i-butyl methacrylate, 20 parts of 2-hydroxyethyl acrylate, 2 parts of acrylic acid, and 4 parts of 2,2′-azobisisobutyronitrile was added thereto dropwise at a constant rate over a period of 3 hours, and the resulting mixture was aged at the same temperature for another 2 hours. Thereafter, a mixture of 10 parts of xylene and 0.5 parts of 2,2′-azobisisobutyronitrile was further added to the reaction vessel dropwise over a period of 1 hour. After completion of the dropwise addition, the resulting mixture was aged for 1 hour, thereby obtaining a hydroxyl-containing acrylic resin (B-4) solution having a nonvolatile content of 55%. The obtained hydroxyl-containing acrylic resin (B-4) had an acid value of 15.6 mg KOH/g, a hydroxyl value of 96.6 mg KOH/g, a weight average molecular weight of 20,000, and a glass transition temperature of 45.6° C.

### Production Example 17

### Production of Hydroxyl-Containing Acrylic Resin (B′-1)

80 parts of xylene was introduced into a reaction vessel equipped with a stirrer, a thermometer, a reflux condenser, and a dropping funnel, and stirred at 100° C. while blowing nitrogen gas thereinto. Then, a mixture of 10 parts of styrene, 20 parts of methyl methacrylate, 8 parts of i-butyl methacrylate, 40 parts of n-butyl acrylate, 20 parts of 2-hydroxyethyl acrylate, 2 parts of acrylic acid, and 4 parts of 2,2′-azobisisobutyronitrile was added thereto dropwise at a constant rate over a period of 3 hours, and the resulting mixture was aged at the same temperature for another 2 hours. Thereafter, a mixture of 10 parts of xylene and 0.5 parts of 2,2′-azobisisobutyronitrile was further added to the reaction vessel dropwise over a period of 1 hour. After completion of the dropwise addition, the resulting mixture was aged for 1 hour, thereby obtaining a hydroxyl-containing acrylic resin (B′-1) solution having a nonvolatile content of 55%. The obtained hydroxyl-containing acrylic resin (B′-1) had an acid value of 15.6 mg KOH/g, a hydroxyl value of 96.6 mg KOH/g, a weight average molecular weight of 20,000, and a glass transition temperature of −14.0° C.

### Production of Urethane Acrylate (E-1)

### Production Example 18

888 parts of isophorone diisocyanate, 464 parts of 2-hydroxyethyl acrylate, and 0.7 parts of hydroquinone monomethyl ether were introduced into a reaction vessel equipped with a thermometer, a thermostat, a stirrer, a reflux condenser, and an air blower. While blowing air into the reaction vessel, the mixture was heated to 80° C., and the temperature was maintained for 5 hours. After confirming that substantially all of the 2-hydroxyethyl acrylate had reacted, 136 parts of pentaerythritol, 372 parts of butyl acetate, and 0.2 parts of dibutyltin dilaurate were added thereto, and the mixture was further maintained at 80° C. After confirming that substantially all of the isophorone diisocyanate had reacted, the mixture was cooled, thereby obtaining a urethane acrylate resin (E-1) solution having a nonvolatile content of 80%. The obtained urethane acrylate resin (E-1) had an unsaturated equivalent of 372.

### Production of Coating Composition

### Example 1

65.5 parts of the 80% solution of the compound (A-1) obtained in Production Example 1 (nonvolatile content: 52.4 parts), 86.6 parts of the 55% solution of the hydroxyl-containing acrylic resin (B-1) obtained in Production Example 13 (nonvolatile content: 47.6 parts), 3.0 parts of Darocur 1173 (trade name, produced by Merck Japan Ltd.; a photoinitiator), and 2.0 parts of TINUVIN 384 (trade name, produced by Ciba Specialty Chemicals; an UV absorber) were uniformly mixed. Then, butyl acetate was added to adjust the nonvolatile content, thereby yielding a coating composition No. 1 having a nonvolatile content of 50%. In the coating composition No. 1, the equivalent ratio of the isocyanate groups (NCO) in the component (A) to the hydroxyl groups (OH) in the component (B) was NCO/OH=0.23. In accordance with the following test panel preparation method, a test panel to which the obtained coating composition No. 1 was applied was produced, and various evaluations were performed with respect thereto. Table 2 shows the evaluation results.

### Examples 2 to 12 and Comparative Examples 1 to 6

Coating compositions No. 2 to 18 of Examples 2 to 12 and Comparative Examples 1 to 6, each having a nonvolatile content of 50%, were obtained as in Example 1, except that the amount of each component was adjusted as shown in Table 2. In accordance with the following test panel preparation method, a test panel to which each coating composition was applied was produced, and various evaluations were performed with respect thereto. Table 2 shows the evaluation results. The amounts of the components shown in Table 2 represent those of nonvolatile content.

TABLE 2

| | | | Example | | | | | | | | |
|---|---|---|---|---|---|---|---|---|---|---|---|
| | | | 1 | 2 | 3 | 4 | 5 | 6 | 7 | 8 | 9 |
| | | | Coating Composition No. | | | | | | | | |
| | | | 1 | 2 | 3 | 4 | 5 | 6 | 7 | 8 | 9 |
| (A) Component | Compound | A-1 | 52.4 | | | | | | | | |
| | | A-2 | | 52.4 | | | | | | | |
| | | A-3 | | | 52.4 | | | | | | |
| | | A-4 | | | | 52.4 | | | | 52.4 | 52.4 |
| | | A-5 | | | | | 52.4 | | | | |
| | | A-6 | | | | | | 52.4 | | | |
| | | A-7 | | | | | | | 52.4 | | |
| | | A′-1 | | | | | | | | | |
| | | A′-2 | | | | | | | | | |
| | | A′-3 | | | | | | | | | |
| | | A′-4 | | | | | | | | | |
| | | A′-5 | | | | | | | | | |
| (B) Component | Hydroxyl- | B-1 | 47.6 | 47.6 | 47.6 | 47.6 | 47.6 | 47.6 | 47.6 | | |
| | Containing Acrylic | B-2 | | | | | | | | 47.6 | |
| | Resin | B-3 | | | | | | | | | 47.6 |
| | | B-4 | | | | | | | | | |
| | | B′-1 | | | | | | | | | |
| (C) Component | Darocur 1173 | | 3.0 | 3.0 | 3.0 | 3.0 | 3.0 | 3.0 | 3.0 | 3.0 | 3.0 |
| UV Absorber | TINUVIN 384 | | 2.0 | 2.0 | 2.0 | 2.0 | 2.0 | 2.0 | 2.0 | 2.0 | 2.0 |
| Functional-Group Ratio | NCO/OH | (Equivalent Ratio) | 0.23 | 0.34 | 0.53 | 0.94 | 1.50 | 0.50 | 0.79 | 0.62 | 0.62 |
| Evaluation Items | Solvent Resistance | | B | B | A | A | A | A | A | A | A |
| | Scratch Resistance | | B | B | A | A | B | B | B | A | A |
| | Weather Resistance | Appearance | B | B | A | A | B | B | B | A | A |
| | | Adhesion | A | A | A | A | A | A | A | A | A |
| | Acid Resistance | | B | B | A | A | A | A | A | A | A |
| | | | Example | | | Comparative Example | | | | | |
| | | | 10 | 11 | 12 | 1 | 2 | 3 | 4 | 5 | 6 |
| | | | Coating Composition No. | | | | | | | | |
| | | | 10 | 11 | 12 | 13 | 14 | 15 | 16 | 17 | 18 |
| (A) Component | Compound | A-1 | 52.4 | | | | | | | | |
| | | A-2 | | | | | | | | | |
| | | A-3 | | | | | | | | | |
| | | A-4 | 52.4 | 64.3 | 33.3 | | | | | | |
| | | A-5 | | | | | | | | | |
| | | A-6 | | | | | | | | | |
| | | A-7 | | | | | | | | | |
| | | A′-1 | | | | 52.4 | | | | | 52.4 |
| | | A′-2 | | | | | 52.4 | | | | |
| | | A′-3 | | | | | | 52.4 | | | |
| | | A′-4 | | | | | | | 52.4 | | |
| | | A′-5 | | | | | | | | 52.4 | |
| (B) Component | Hydroxyl- | B-1 | | 35.7 | 66.7 | 47.6 | 47.6 | 47.6 | 47.6 | 47.6 | |
| | Containing Acrylic | B-2 | | | | | | | | | |
| | Resin | B-3 | | | | | | | | | |
| | | B-4 | 47.6 | | | | | | | | |
| | | B′-1 | | | | | | | | | 47.6 |
| (C) Component | Darocur 1173 | | 3.0 | 3.0 | 3.0 | 3.0 | 3.0 | 3.0 | 3.0 | 3.0 | 3.0 |
| UV Absorber | TINUVIN 384 | | 2.0 | 2.0 | 2.0 | 2.0 | 2.0 | 2.0 | 2.0 | 2.0 | 2.0 |
| Functional-Group Ratio | NCO/OH | (Equivalent Ratio) | 0.62 | 1.53 | 0.43 | 0.00 | 0.13 | 2.84 | 0.78 | 1.82 | 0.00 |
| Evaluation Items | Solvent Resistance | | A | A | A | B | B | B | B | B | B |
| | Scratch Resistance | | A | A | B | B | B | D | C | C | D |
| | Weather Resistance | Appearance | A | A | B | C | C | B | D | D | D |
| | | Adhesion | A | A | A | D | D | A | D | D | D |
| | Acid Resistance | | A | A | A | B | B | B | B | B | B |

### Test Panel Preparation Method

Each coating composition was applied to a polymethyl methacrylate resin panel by air spray coating to a dry film thickness of 20 μm. Subsequently, each of the coated panels was preheated at 50° C. for 3 minutes, and then irradiated with an active energy ray at a dose of 1,500 mJ/cm² with an ultra-high-pressure mercury lamp. Thereafter, the resulting panel was dried at 90° C. for 10 minutes, thereby obtaining a test panel.

### Example 13

31.3 parts of the 80% solution of the compound (A-1) obtained in Production Example 1 (nonvolatile content: 25.0 parts), 113.6 parts of the 55% solution of the hydroxyl-containing acrylic resin (B-1) obtained in Production Example 13 (nonvolatile content: 62.5 parts), 3.0 parts of Darocur 1173, 12.5 parts of an isocyanurate ring adduct of hexamethylene diisocyanate (NCO content: 21%), and 2.0 parts of TINUVIN were uniformly mixed. Then, butyl acetate was added to adjust the nonvolatile content, thereby yielding a coating composition No. 19 having a nonvolatile content of 50%. In the coating composition No. 19, the equivalent ratio of the entire amount of the isocyanate groups (NCO) in the component (A) and the component (D) to the hydroxyl groups (OH) in the component (B) was NCO/OH=0.77, and the equivalent ratio of the isocyanate groups (NCO) in the component (A) to the isocyanate groups (NCO) in Component D was NCO in the component (A)/NCO in the component (D)=0.12. In accordance with the test panel preparation method described above, a test panel to which the obtained coating composition No. 19 was applied was produced, and various evaluations were performed with respect thereto. Table 3 shows the evaluation results.

### Examples 14 to 25 and Comparative Examples 7 to 12

Coating compositions No. 20 to 37 of Examples 14 to 25 and Comparative Examples 7 to 12, each having a nonvolatile content of 50%, were obtained as in Example 13, except that the amount of each component was adjusted as shown in Table 3. In accordance with the test panel preparation method described above, a test panel to which each coating composition was applied was produced, and various evaluations were performed with respect thereto. Table 3 shows the evaluation results. The amounts of the components shown in Table 3 represent those of nonvolatile content.

TABLE 3

| | | | Example | | | | | | | | | | |
|---|---|---|---|---|---|---|---|---|---|---|---|---|---|
| | | | 13 | 14 | 15 | 16 | 17 | 18 | 19 | 20 | 21 | 22 | 23 |
| | | | Coating Composition No. | | | | | | | | | | |
| | | | 19 | 20 | 21 | 22 | 23 | 24 | 25 | 26 | 27 | 28 | 29 |
| (A) Component | Compound | A-1 | 25.0 | | | | | | | | | | |
| | | A-2 | | 25.0 | | | | | | | | | |
| | | A-3 | | | 25.0 | | | | | | | | |
| | | A-4 | | | | 25.0 | | | | 25.0 | 25.0 | 25.0 | 45.5 |
| | | A-5 | | | | | 25.0 | | | | | | |
| | | A-6 | | | | | | 25.0 | | | | | |
| | | A-7 | | | | | | | 25.0 | | | | |
| | | A′-1 | | | | | | | | | | | |
| | | A′-2 | | | | | | | | | | | |
| | | A′-3 | | | | | | | | | | | |
| | | A′-4 | | | | | | | | | | | |
| | | A′-5 | | | | | | | | | | | |
| (B) Component | Hydroxyl-Containing | B-1 | 62.5 | 62.5 | 62.5 | 62.5 | 62.5 | 62.5 | 62.5 | | | | 45.5 |
| | Acrylic Resin | B-2 | | | | | | | | 62.5 | | | |
| | | B-3 | | | | | | | | | 62.5 | | |
| | | B-4 | | | | | | | | | | 62.5 | |
| | | B′-1 | | | | | | | | | | | |
| (C) Component | Darocur 1173 | | 3.0 | 3.0 | 3.0 | 3.0 | 3.0 | 3.0 | 3.0 | 3.0 | 3.0 | 3.0 | 3.0 |
| (D) Component | Isocyanurate Ring Adduct of | | 12.5 | 12.5 | 12.5 | 12.5 | 12.5 | 12.5 | 12.5 | 12.5 | 12.5 | 12.5 | 9.0 |
| | Hexamethylene Diisocyanate | | | | | | | | | | | | |
| UV Absorber | TINUVIN 384 | | 2.0 | 2.0 | 2.0 | 2.0 | 2.0 | 2.0 | 2.0 | 2.0 | 2.0 | 2.0 | 2.0 |
| Functional-Group Ratio | NCO/OH | (Equivalent Ratio) | 0.77 | 0.81 | 0.88 | 1.03 | 1.24 | 0.87 | 0.98 | 0.69 | 0.69 | 0.69 | 1.54 |
| | NCO in Component (A)/NCO in | | 0.12 | 0.18 | 0.28 | 0.49 | 0.79 | 0.27 | 0.42 | 0.49 | 0.49 | 0.49 | 1.23 |
| | Component (D) | | | | | | | | | | | | |
| Evaluation Items | Solvent Resistance | | A | A | A | A | A | A | A | A | A | A | A |
| | Scratch Resistance | | B | A | A | A | B | B | B | A | A | A | A |
| | Weather Resistance | Appearance | B | A | A | A | B | B | B | A | A | A | A |
| | | Adhesion | A | A | A | A | A | A | A | A | A | A | A |
| | Acid Resistance | | B | B | A | A | A | A | A | A | A | A | A |

| | | | Example | | Comparative Example | | | | | |
|---|---|---|---|---|---|---|---|---|---|---|
| | | | 24 | 25 | 7 | 8 | 9 | 10 | 11 | 12 |
| | | | Coating Composition No. | | | | | | | |
| | | | 30 | 31 | 32 | 33 | 34 | 35 | 36 | 37 |
| (A) Component | Compound | A-1 | | | | | | | | |
| | | A-2 | | | | | | | | |
| | | A-3 | | | | | | | | |
| | | A-4 | 14.3 | 34.3 | | | | | | |
| | | A-5 | | | | | | | | |
| | | A-6 | | | | | | | | |
| | | A-7 | | | | | | | | |
| | | A′-1 | | | 25.0 | | | | | 25.0 |
| | | A′-2 | | | | 25.0 | | | | |
| | | A′-3 | | | | | 25.0 | | | |
| | | A′-4 | | | | | | 25.0 | | |
| | | A′-5 | | | | | | | 25.0 | |
| (B) Component | Hydroxyl-Containing | B-1 | 71.4 | 57.1 | 62.5 | 62.5 | 62.5 | 62.5 | 62.5 | |
| | Acrylic Resin | B-2 | | | | | | | | |
| | | B-3 | | | | | | | | |
| | | B-4 | | | | | | | | |
| | | B′-1 | | | | | | | | 62.5 |
| (C) Component | Darocur 1173 | | 3.0 | 3.0 | 3.0 | 3.0 | 3.0 | 3.0 | 3.0 | 3.0 |
| (D) Component | Isocyanurate Ring Adduct of | | 14.3 | 8.6 | 12.5 | 12.5 | 12.5 | 12.5 | 12.5 | 12.5 |
| | Hexamethylene Diisocyanate | | | | | | | | | |
| UV Absorber | TINUVIN 384 | | 2.0 | 2.0 | 2.0 | 2.0 | 2.0 | 2.0 | 2.0 | 2.0 |
| Functional-Group Ratio | NCO/OH | (Equivalent Ratio) | 0.86 | 1.03 | 0.69 | 0.74 | 1.72 | 0.97 | 1.35 | 0.7 |
| | NCO in Component (A)/NCO in | | 0.25 | 0.99 | 0.00 | 0.07 | 1.50 | 0.41 | 0.96 | 0.0 |
| | Component (D) | | | | | | | | | |
| Evaluation Items | Solvent Resistance | | A | A | B | B | B | B | B | B |
| | Scratch Resistance | | A | A | B | B | D | C | C | D |
| | Weather Resistance | Appearance | A | A | C | C | B | D | D | D |
| | | Adhesion | A | A | D | D | A | D | D | D |
| | Acid Resistance | | A | A | B | B | B | B | B | B |

### Example 26

26.4 parts of the 80% solution of Compound (A-1) obtained in Production Example 1 (nonvolatile content: 21.1 parts), 95.6 parts of the 55% solution of the hydroxyl-containing acrylic resin (B-1) obtained in Production Example 13 (nonvolatile content: 52.6 parts), 3.0 parts of Darocur 1173, 10.5 parts of an isocyanurate ring adduct of hexamethylene diisocyanate (NCO content: 21%), 19.8 parts of the 80% solution of urethane acrylate resin (E-1) obtained in Production Example 15 (nonvolatile content: 15.8 parts), 2.0 parts of TINUVIN 384 were uniformly mixed. Then, butyl acetate was added to adjust the nonvolatile content, thereby yielding a coating composition No. 38 having a nonvolatile content of 50%. In the coating composition No. 38, the equivalent ratio of the entire amount of the isocyanate groups (NCO) in the component (A) and the component (D) to the hydroxyl groups (OH) in the component (B) was NCO/OH=0.77, and the equivalent ratio of the isocyanate groups (NCO) in the component (A) to the isocyanate groups (NCO) in Component (D) was NCO in the component (A)/NCO in the component (D)=0.12. In accordance with the test panel preparation method described above, a test panel to which the obtained coating composition No. 38 was applied was produced, and various evaluations were performed with respect thereto. Table 4 shows the evaluation results.

### Examples 27 to 44 and Comparative Examples 13 to 18

Coating compositions No. 39 to 56 and 58 to 63 of Examples 27 to 44 and Comparative Examples 13 to 18, each having a nonvolatile content of 50%, were obtained as in Example 26, except that the amount of each component was adjusted as shown in Table 4. In accordance with the test panel preparation method described above, a test panel to which each coating composition was applied was produced, and various evaluations were performed with respect thereto. Table 4 shows the evaluation results. The amounts of the components shown in Table 4 represent those of nonvolatile content.

### Example 45

A coating composition No. 57 of Example 45 having a nonvolatile content of 50% was obtained as in Example 26, except that the amount of each component was adjusted as shown in Table 4. The obtained coating composition No. 57 was applied to a polymethyl methacrylate resin panel by air spray coating to a dry film thickness of 40 μm. Subsequently, the coated panel was preheated at 50° C. for 3 minutes, and then irradiated with an active energy ray at a dose of 1,500 mJ/cm² with D valve produced by Fusion UV Systems, Inc. Thereafter, the panel was dried at 90° C. for 10 minutes, thereby obtaining a test panel. Various evaluations were performed with respect to the obtained test panel. Table 4 shows the evaluation results.

TABLE 4

| | | | Example | | | | | | | | | | | | |
|---|---|---|---|---|---|---|---|---|---|---|---|---|---|---|---|
| | | | 26 | 27 | 28 | 29 | 30 | 31 | 32 | 33 | 34 | 35 | 36 | 37 | 38 |
| | | | Coating Composition No. | | | | | | | | | | | | |
| | | | 38 | 39 | 40 | 41 | 42 | 43 | 44 | 45 | 46 | 47 | 48 | 49 | 50 |
| (A) Component | Compound | A-1 | 21.1 | | | | | | | | | | | | |
| | | A-2 | | 21.1 | | | | | | | | | | 21.1 | |
| | | A-3 | | | 21.1 | | | | | | | | | | |
| | | A-4 | | | | 21.1 | | | | 21.1 | 21.1 | 21.1 | 21.1 | | 40.0 |
| | | A-5 | | | | | 21.1 | | | | | | | | |
| | | A-6 | | | | | | 21.1 | | | | | | | |
| | | A-7 | | | | | | | 21.1 | | | | | | |
| | | A′-1 | | | | | | | | | | | | | |
| | | A′-2 | | | | | | | | | | | | | |
| | | A′-3 | | | | | | | | | | | | | |
| | | A′-4 | | | | | | | | | | | | | |
| | | A′-5 | | | | | | | | | | | | | |
| (B) Component | Hydroxyl-Containing | B-1 | 52.6 | 52.6 | 52.6 | 52.6 | 52.6 | 52.6 | 52.6 | | | | 52.6 | 52.6 | 40.0 |
| | Acrylic Resin | B-2 | | | | | | | | 52.6 | | | | | |
| | | B-3 | | | | | | | | | 52.6 | | | | |
| | | B-4 | | | | | | | | | | 52.6 | | | |
| | | B′-1 | | | | | | | | | | | | | |
| (C) Component | Darocur 1173 | | 3.0 | 3.0 | 3.0 | 3.0 | 3.0 | 3.0 | 3.0 | 3.0 | 3.0 | 3.0 | 3.0 | 3.0 | 3.0 |
| | Irgacure 819 | | | | | | | | | | | | | | |
| (D) Component | Isocyanurate Ring Adduct of | | 10.5 | 10.5 | 10.5 | 10.5 | 10.5 | 10.5 | 10.5 | 10.5 | 10.5 | 10.5 | 10.5 | 10.5 | 8.0 |
| | Hexamethylene Diisocyanate | | | | | | | | | | | | | | |
| (E) Component | Urethane Acrylate Resin (E-1) | | 15.8 | 15.8 | 15.8 | 15.8 | 15.8 | 15.8 | 15.8 | 15.8 | 15.8 | 15.8 | | | 12.0 |
| | Trimethylolpropane Triacrylate | | | | | | | | | | | | 15.8 | 15.8 | |
| UV Absorber | TINUVIN 384 | | 2.0 | 2.0 | 2.0 | 2.0 | 2.0 | 2.0 | 2.0 | 2.0 | 2.0 | 2.0 | 2.0 | 2.0 | 2.0 |
| Functional- | NCO/OH | (Molar Ratio) | 0.77 | 0.81 | 0.88 | 1.03 | 1.24 | 0.87 | 0.98 | 0.69 | 0.69 | 0.69 | 1.03 | 0.81 | 1.54 |
| Group Ratio | NCO in Component (A)/NCO in | | 0.12 | 0.18 | 0.28 | 0.49 | 0.79 | 0.27 | 0.42 | 0.49 | 0.49 | 0.49 | 0.49 | 0.18 | 1.23 |
| | Component (D) | | | | | | | | | | | | | | |
| Evaluation | Solvent Resistance | | A | A | A | A | A | A | A | A | A | A | A | A | A |
| Items | Scratch Resistance | | A | A | A | A | A | A | A | A | A | A | A | A | A |
| | Weather Resistance | Appearance | B | A | A | A | B | B | B | A | A | A | A | A | A |
| | | Adhesion | A | A | A | A | A | A | A | A | A | A | A | A | A |
| | Acid Resistance | | B | B | A | A | A | A | A | A | A | A | A | B | A |

TABLE 5
(Continued from Table 4)

| | | | Example | | | | | | | Comparative Example | | | | | |
|---|---|---|---|---|---|---|---|---|---|---|---|---|---|---|---|
| | | | 39 | 40 | 41 | 42 | 43 | 44 | 45 | 13 | 14 | 15 | 16 | 17 | 18 |
| | | | Coating Composition No. | | | | | | | | | | | | |
| | | | 51 | 52 | 53 | 54 | 55 | 56 | 57 | 58 | 59 | 60 | 61 | 62 | 63 |
| (A) Component | Compound | A-1 | | | | | | | | | | | | | |
| | | A-2 | | | | | | | | | | | | | |
| | | A-3 | | | | | | | | | | | | | |
| | | A-4 | 11.8 | 29.3 | 23.5 | 19.1 | 26.7 | 21.1 | 21.1 | | | | | | |
| | | A-5 | | | | | | | | | | | | | |
| | | A-6 | | | | | | | | | | | | | |
| | | A-7 | | | | | | | | | | | | | |
| | | A′-1 | | | | | | | | 21.1 | | | | | 21.1 |
| | | A′-2 | | | | | | | | | 21.1 | | | | |
| | | A′-3 | | | | | | | | | | 21.1 | | | |
| | | A′-4 | | | | | | | | | | | 21.1 | | |
| | | A′-5 | | | | | | | | | | | | 21.1 | |
| (B) Component | Hydroxyl-Containing | B-1 | 58.8 | 48.8 | 58.8 | 47.6 | 44.4 | 52.6 | 52.6 | 52.6 | 52.6 | 52.6 | 52.6 | 52.6 | |
| | Acrylic Resin | B-2 | | | | | | | | | | | | | |
| | | B-3 | | | | | | | | | | | | | |
| | | B-4 | | | | | | | | | | | | | |
| | | B′-1 | | | | | | | | | | | | | 52.6 |
| (C) Component | Darocur 1173 | | 3.0 | 3.0 | 3.0 | 3.0 | 3.0 | 3.0 | 3.0 | 3.0 | 3.0 | 3.0 | 3.0 | 3.0 | 3.0 |
| | Irgacure 819 | | | | | | | | 0.5 | | | | | | |
| (D) Component | Isocyanurate Ring Adduct of | | 11.8 | 7.3 | 11.8 | 9.5 | 6.7 | 10.5 | 10.5 | 10.5 | 10.5 | 10.5 | 10.5 | 10.5 | 10.5 |
| | Hexamethylene Diisocyanate | | | | | | | | | | | | | | |
| (E) Component | Urethane Acrylate Resin (E-1) | | 17.6 | 14.6 | 5.9 | 23.8 | 22.2 | 15.8 | 15.8 | 15.8 | 15.8 | 15.8 | 15.8 | 15.8 | 15.8 |
| | Trimethylolpropane Triacrylate | | | | | | | | | | | | | | |
| UV Absorber | TINUVIN 384 | | 2.0 | 2.0 | 2.0 | 2.0 | 2.0 | 0.0 | 2.0 | 2.0 | 2.0 | 2.0 | 2.0 | 2.0 | 2.0 |
| Functional-Group | NCO/OH | (Equivalent | 0.86 | 1.03 | 1.03 | 1.03 | 1.03 | 1.03 | 1.03 | 0.69 | 0.74 | 1.72 | 0.97 | 1.35 | 0.69 |
| Ratio | | Ratio) | | | | | | | | | | | | | |
| | NCO in Component (A)/NCO in | | 0.25 | 0.99 | 0.49 | 0.49 | 0.99 | 0.49 | 0.49 | 0.00 | 0.07 | 1.50 | 0.41 | 0.96 | 0.00 |
| | Component (D) | | | | | | | | | | | | | | |
| Evaluation | Solvent Resistance | | A | A | A | A | A | A | A | B | B | B | B | B | B |
| Items | Scratch Resistance | | B | A | A | A | A | A | A | B | B | D | C | C | D |
| | Weather Resistance | Appearance | A | A | A | A | A | B | A | C | C | B | D | D | D |
| | | Adhesion | A | A | A | A | A | A | A | D | D | A | D | D | D |
| | Acid Resistance | | A | A | A | A | A | A | A | B | B | B | B | B | B |

### Test Method 1

### Solvent Resistance

The coating surface of the test panel was rubbed back and forth with a gauze soaked in acetone over a length of about 5 cm under pressure at a load of about 1 kg/cm² until traces thereof remained. Then, the number of reciprocations was counted to evaluate the solvent resistance in accordance with the following criteria.

A: No traces were observed, even after 200 reciprocations
B: Traces were observed after 100 to 200 reciprocations
C: Traces were observed after 50 to 99 reciprocations
D: Traces were observed after 49 or fewer reciprocations

### Scratch Resistance

Each test panel was subjected to a Taber abrasion test (abrading wheel CF-10P, a 500 g load, 100 cycles) according to ASTM D1044. The surface glossiness of each coating film before and after the test was measured based on the specular gloss (60 degrees) according to JIS K5600-4-7 (1999). The gloss retention (%) was calculated based on the glossiness after the test relative to the glossiness before the test, and evaluated according to the following criteria.

A: Gloss retention of 90% or more
B: Gloss retention of 80% or more, and less than 90%
C: Gloss retention of 60% or more, and less than 80%
D: Gloss retention of less than 60%

### Weather Resistance

Each test panel was subjected to a 2,000-hour weathering test using a Sunshine Weather-Ometer according to JIS K 5600-7-8 (1999). The appearance and adhesion of the test panel after the test were evaluated.

### Appearance

A: No defects were observed on the surface of the coating film, and the color difference ΔE based on JIS Z 8730 between the test panel at the initial stage and that after the test was less than 0.3.
B: Slight yellowing was observed, and the color difference ΔE based on JIS Z 8730 between the test panel at the initial stage and that after the test was 0.3 or more, and less than 0.5, which does not pose practical problems.
C: Yellowing was observed in the coating film, and the color difference ΔE based on JIS Z 8730 between the test panel at the initial stage and after the test was 0.5 or more, and less than 0.8.
D: Yellowing was observed in the coating film, and the color differences ΔE based on JIS Z 8730 between the test panel at the initial stage and after the test was 0.8 or more, or cracks were observed.

### Adhesion

A grid of 100 squares (2 mm×2 mm) was formed on the surface of each coating film according to JIS K 5600-5-6 (1990), and an adhesive tape was applied to the grid portion. After the adhesive tape was abruptly peeled off, the number of grid squares remaining on the surface of the coating film was evaluated.

A: Remaining number/Total number=100 squares/100 squares
C: Remaining number/Total number=99 to 90 squares/100 squares
D: Remaining number/Total number=89 squares or less/100 squares

### Acid Resistance

0.5 mL of a 1% aqueous sulfuric acid solution was added to the surface of each coating film dropwise, and the resulting product was allowed to stand at 20° C. and 65% RH for 24 hours. Thereafter, the surface of the coating film was wiped off with a gauze, and the appearance was visually evaluated.

A: No defects were observed on the surface of the coating film.
B: A slight trace was observed on the surface of the coating film, but the trace disappeared when washed with water.
C: Change in color or slight blushing was observed on the surface of the coating film.
D: Significant change in color or blushing was observed on the surface of the coating film.

### Production of Hydroxyl-Containing Acrylic Resin Emulsion

### Production Example 19

### Hydroxyl-Containing Acrylic Resin Emulsion

130 parts of deionized water and 0.52 parts of Aqualon KH-10 (Note 4) were introduced into a reaction vessel equipped with a thermometer, a thermostat, a stirrer, a reflux condenser, and a dropping funnel. The resulting mixture was stirred in a nitrogen stream, and heated to 80° C. Thereafter, 1% of the total amount of the monomer emulsion (1) described below and 5.3 parts of a 6% aqueous ammonium persulfate solution were introduced into the reaction vessel, and the mixture was maintained at 80° C. for 15 minutes. Thereafter, the remaining monomer emulsion (1) was added dropwise to the reaction vessel retained at the same temperature over a period of 3 hours. After completion of the dropwise addition, the mixture was aged for 1 hour. Thereafter, the monomer emulsion (2) described below was added thereto dropwise over a period of 1 hour, and the mixture was aged for 1 hour. While 40 parts of a 5% aqueous dimethylethanolamine solution was gradually added to the reaction vessel, the mixture was cooled to 30° C. The resulting mixture was discharged while filtered with a 100-mesh nylon cloth, and a hydroxyl-containing acrylic resin emulsion having an average particle diameter of 100 nm (as measured at 20° C. using a “COULTER N4” submicron particle size distribution analyzer (produced by Beckman Coulter, Inc.) in a state diluted with deionized water) was obtained. The obtained hydroxyl-containing acrylic resin emulsion had a nonvolatile content of 30%, an acid value of 33 mg KOH/g, and a hydroxyl value of 25 mg KOH/g.

(Note 4) Aqualon KH-10: a polyoxyethylene alkyl ether sulfate ester ammonium salt produced by Dai-ichi Kogyo Seiyaku Co., Ltd., active ingredient: 97%.
Monomer emulsion (1): 42 parts of deionized water, 0.72 parts of Aqualon KH-10 (see Note 4), 2.1 parts of methylenebis acrylamide, 2.8 parts of styrene, 16.1 parts of methyl methacrylate, 28 parts of ethyl acrylate, and 21 parts of n-butyl acrylate were mixed and stirred to obtain a monomer emulsion (1).
Monomer emulsion (2): 18 parts of deionized water, 0.31 parts of Aqualon KH-10 (see Note 4), 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate, and 9 parts of n-butyl acrylate were mixed and stirred to obtain a monomer emulsion (2).

### Production of Hydroxyl-Containing Polyester Resin

### Production Example 20

### Production of Hydroxyl-Containing Polyester Resin Solution (PE1)

109 parts of trimethylolpropane, 141 parts of 1,6-hexanediol, 126 parts of hexahydrophthalic anhydride, and 120 parts of adipic acid were introduced into a reaction vessel equipped with a thermometer, a thermostat, a stirrer, a reflux condenser, and a water separator, and the mixture was heated from 160° C. to 230° C. over a period of 3 hours, followed by a condensation reaction at 230° C. for 4 hours. Subsequently, 38.3 parts of trimellitic anhydride was further added thereto so as to add a carboxyl group to the resulting condensation reaction product, and the resulting product was allowed to react at 170° C. for 30 minutes. The reaction product was diluted with 2-ethyl-1-hexanol to obtain a hydroxyl-containing polyester resin solution (PE1) having an acid value of 46 mg KOH/g, a hydroxyl value of 150 mg KOH/g, a nonvolatile content of 70%, and a weight average molecular weight of 6,400.

### Production Example 21

### Production of Hydroxyl-Containing Polyester Resin Solution (PE2)

A hydroxyl-containing polyester resin solution (PE2) was obtained as in Production Example 20, except that the dilution solvent was changed from 2-ethyl-1-hexanol to ethylene glycol mono-n-butyl ether.

### Production of Effect Pigment Concentrate

### Production Example 22

### Production of Effect Pigment Concentrate (P1)

In a stirring vessel, 19 parts of aluminum pigment paste (GX-180A) (produced by Asahi Kasei Metals Ltd.; metal content: 74%), 35 parts of 2-ethyl-1-hexanol, 8 parts of phosphate group-containing resin solution (Note 5), and 0.2 parts of 2-(dimethylamino)ethanol were uniformly mixed to obtain an effect pigment concentrate (P1).

(Note 5) Phosphate group-containing resin solution: a combined solvent of 27.5 parts of methoxypropanol and 27.5 parts of isobutanol was introduced into a reaction vessel equipped with a thermometer, a thermostat, a stirrer, a reflux condenser, and a dropping funnel, and heated to 110° C. Then, 121.5 parts of a mixture comprising 25 parts of styrene, 27.5 parts of n-butyl methacrylate, 20 parts of “Isostearyl Acrylate” (trade name, produced by Osaka Organic Chemical Industry Ltd., a branched higher alkyl acrylate), 7.5 parts of 4-hydroxybutylacrylate, 15 parts of a phosphate group-containing polymerizable-monomer (Note 6), 12.5 parts of 2-methacryloyloxyethyl acid phosphate, 10 parts of isobutanol, and 4 parts of t-butyl peroxyoctanoate was added to the above-mentioned combined solvent over a period of 4 hours. Further, a mixture comprising 0.5 parts of t-butyl peroxyoctanoate, and 20 parts of isopropanol was added thereto dropwise for 1 hour. The mixture was then stirred and aged for 1 hour to obtain a phosphate group-containing resin solution having a nonvolatile content of 50%. The resin had an acid value attributable to the phosphate groups of 83 mg KOH/g, a hydroxyl value attributable to the 4-hydroxybutylacrylate of 29 mg KOH/g, and a weight average molecular weight of 10,000.
(Note 6) Phosphate group-containing polymerizable monomer: 57.5 parts of monobutyl phosphoric acid and 41 parts of isobutanol were introduced into a reaction vessel equipped with a thermometer, a thermostat, a stirrer, a reflux condenser, and a dropping funnel, and heated to 90° C. Thereafter, 42.5 parts of glycidyl methacrylate was added thereto dropwise over a period of 2 hours, and the resulting mixture was stirred and aged for another 1 hour. Subsequently, 59 parts of isopropanol was added thereto to obtain a phosphate group-containing polymerizable monomer solution having a nonvolatile content of 50%. The monomer had an acid value attributable to the phosphate groups of 285 mg KOH/g.

### Production Example 23

### Production of Effect Pigment Concentrate (P2)

An effect pigment concentrate (P2) was obtained as in Production Example 22, except that 35 parts of 2-ethyl-1-hexanol was replaced with 35 parts of ethylene glycol mono-n-butyl ether.

### Production of Base Coating Composition

### Production Example 24

### Production of Base Coating Composition No. 1

150 parts of the hydroxyl-containing acrylic resin emulsion obtained in Production Example 19, 64 parts of the hydroxyl-containing polyester resin solution (PE1) obtained in Production Example 20, 62 parts of the effect pigment concentrate (P1) obtained in Production Example 22, and 12.5 parts of Cymel 202 (trade name, produced by Nihon Cytec Industries Inc., a melamine resin, nonvolatile content: 80%) were uniformly mixed. Then, deionized water and 2-(dimethylamino)ethanol were added thereto to yield a base coating composition No. 1 having a pH of 8.0 and a nonvolatile content of 23%.

### Production Example 25

### Production of Base Coating Composition No. 2

150 parts of the hydroxyl-containing acrylic resin emulsion obtained in Production Example 19, 64 parts of the hydroxyl-containing polyester resin solution (PE2) obtained in Production Example 21, 62 parts of the effect pigment concentrate (P2) obtained in Production Example 23, and 12.5 parts of Cymel 202 were uniformly mixed. Then, deionized water and 2-(dimethylamino)ethanol were added thereto to yield a base coating composition No. 2 having a pH of 8.0 and a nonvolatile content of 23%.

### Production of Substrate A

A cationic electrodeposition coating composition “ELECRON GT-10” (trade name, produced by Kansai Paint Co., Ltd., containing an epoxy resin/polyamine-based cationic resin and a blocked polyisocyanate compound as a curing agent) was applied to a degreased and zinc phosphate-treated cold-rolled steel plate (JIS G3020, size: 400×300×0.8 mm) by electrodeposition to a film thickness of 20 μm when cured, heated at 170° C. for 20 minutes, and cured by crosslinking; thereby obtaining an electrodeposition coating film.

An intermediate coating composition “LUGA BAKE TP-65-2 (white coating color)” (produced by Kansai Paint Co., Ltd., polyester resin-melamine resin based organic solvent type) was applied to the surface of the obtained electrodeposition coating film by air spray coating to a film thickness of 30 μm when cured. The resulting film was heated at 140° C. for 30 minutes to be cured by crosslinking, thereby obtaining, as a substrate A, a coated panel comprising an intermediate coating film.

### Production of Substrate B

Polypropylene NX-280AK (produced by Mitsubishi Petrochemical Co., Ltd., panel thickness: 3.2 mm) was subjected to vapor degreasing with trichloroethane for 1 minute, and then dried at 80° C. for 10 minutes. Subsequently, “Soflex No. 1000” (produced by Kansai Paint Co., Ltd., a polyolefin-containing electrically conductive organic solvent-type primer) was applied thereto as a primer to a dry film thickness of 15 μm. Then, setting was performed at ordinary temperature for 3 minutes to obtain a substrate.

### Production of Substrate C

Polypropylene NX-280AK (produced by Mitsubishi Petrochemical Co., Ltd., panel thickness: 3.2 mm) was subjected to vapor degreasing with trichloroethane for 1 minute, and then dried at 80° C. for 10 minutes. Subsequently, “ASCALEX #2850” (trade name, produced by Kansai Paint Co., Ltd., a polyolefin-containing electrically conductive aqueous primer coating composition) was applied thereto as a primer to a dry film thickness of 15 μm. Then, setting was performed at ordinary temperature for 5 minutes to obtain a substrate.

### Production of Substrate D

Polypropylene NX-280AK (produced by Mitsubishi Petrochemical Co., Ltd., panel thickness: 3.2 mm) was subjected to vapor degreasing with trichloroethane for 1 minute, and then dried at 80° C. for 10 minutes. Subsequently, “ASCALEX #2850” (trade name, produced by Kansai Paint Co., Ltd., a polyolefin-containing electrically conductive aqueous primer coating composition) was applied thereto as a primer to a dry film thickness of 15 μm. Then, preliminary heating (preheating) was performed at 80° C. for 3 minutes to obtain a substrate.

### Method for Forming a Multilayer Coating Film

### Example 46

The base coating composition No. 1 obtained in Production Example 24 was applied to the substrate A to a dry film thickness of 15 μm using a rotary atomization coater, and preheating was performed at 80° C. for 3 minutes. The coating composition No. 1 obtained in Example 1 was then applied thereto as a clear coating composition by air spray coating to a dry film thickness of 20 μm. Subsequently, the coated substrate was preheated at 50° C. for 3 minutes, and then irradiated with an active energy ray at a dose of 1,500 mJ/cm² with an ultra-high-pressure mercury lamp. Thereafter, the resulting substrate was dried at 90° C. for 10 minutes, thereby obtaining a test panel. The heating steps were performed 5 times (as a total number of preheating and drying by heating performed with respect to the electrodeposition coating film, the intermediate coating film, the base coating film, and the clear coating film) before the test panel was obtained. Table 6 shows the evaluation results regarding the obtained test panels.

### Examples 47 to 93 and Comparative Examples 19 to 36

A test panel was produced as in Example 46, except that the base coating composition and the clear coating composition were respectively replaced with the base coating composition and the clear coating composition shown in Tables 6 to 9, and various evaluations were performed with respect to the produced test panels. Tables 6 to 9 show the evaluation results.

### Example 94

The base coating composition No. 1 obtained in Production Example 24 was applied to the substrate A to a dry film thickness of 15 μm using a rotary atomization coater, and preheating was performed at 80° C. for 3 minutes.

The coating composition No. 57 obtained in Example 45 was then applied thereto as a clear coating composition by air spray coating to a dry film thickness of 40 μm. Subsequently, the coated substrate was preheated at 50° C. for 3 minutes, and then irradiated with an active energy ray at a dose of 1,500 mJ/cm² with D valve produced by Fusion UV Systems, Inc. Thereafter, the resulting substrate was dried at 90° C. for 10 minutes, thereby obtaining a test panel. The obtained test panel was then subjected to evaluation. Table 9 shows the evaluation results.

### Example 95

The base coating composition No. 1 obtained in Production Example 24 was applied to the substrate A to a dry film thickness of 15 μm using a rotary atomization coater, and preheating was performed at 80° C. for 3 minutes.

The coating composition No. 57 obtained in Example 45 was then applied thereto as a clear coating composition to a dry film thickness of 40 μm by air spray coating. Subsequently, the coated substrate was dried at 90° C. for 10 minutes, and then irradiated with an active energy ray at a dose of 1,500 mJ/cm² with D valve produced by Fusion UV Systems, Inc., to obtain a test panel. The obtained test panel was subjected to evaluation. Table 9 shows the evaluation results.

TABLE 6

| | | | Example | | | | | | | | | |
|---|---|---|---|---|---|---|---|---|---|---|---|---|
| | | | 46 | 47 | 48 | 49 | 50 | 51 | 52 | 53 | 54 | 55 |
| Substrate | | | A | A | A | A | A | A | A | A | A | A |
| Base Coating Composition No. | | | 1 | 1 | 1 | 1 | 1 | 1 | 1 | 1 | 1 | 1 |
| Preheat | | | Yes | Yes | Yes | Yes | Yes | Yes | Yes | Yes | Yes | Yes |
| Coating Composition (Clear Coating Composition) No. | | | 1 | 2 | 3 | 4 | 5 | 6 | 7 | 8 | 9 | 10 |
| Evaluation Items | Solvent Resistance | (Note 7) | B | B | A | A | A | A | A | A | A | A |
| | Adhesion | (Note 8) | B | B | B | A | A | B | A | B | B | B |
| | Finishing Appearance | Visual | A | A | A | A | B | A | A | A | A | A |
| | | Observation | | | | | | | | | | |
| | (Note 9) | Gloss | A | A | A | A | B | A | A | A | A | A |
| | Scratch Resistance | (Note 10) | B | B | A | A | B | B | B | A | A | A |
| | Weather Resistance | Appearance | B | B | A | A | B | B | B | A | A | A |
| | (Note 11) | Adhesion | A | A | A | A | A | A | A | A | A | A |
| | Acid Resistance | (Note 12) | B | B | A | A | A | A | A | A | A | A |

| | | | | | | | | | | |
|---|---|---|---|---|---|---|---|---|---|---|
| Comprehensive Evaluation | B | B | B | A | B | B | B | B | B | B |

| | | | Example | | | Comparative Example | | | | | |
|---|---|---|---|---|---|---|---|---|---|---|---|
| | | | 56 | 57 | 58 | 19 | 20 | 21 | 22 | 23 | 24 |
| Substrate | | | A | A | A | A | A | A | A | A | A |
| Base Coating Composition No. | | | 1 | 1 | 2 | 1 | 1 | 1 | 1 | 1 | 1 |
| Preheat | | | Yes | Yes | Yes | Yes | Yes | Yes | Yes | Yes | Yes |
| Coating Composition (Clear Coating Composition) No. | | | 11 | 12 | 4 | 13 | 14 | 15 | 16 | 17 | 18 |
| Evaluation Items | Solvent Resistance | (Note 7) | A | A | A | B | B | B | B | B | B |
| | Adhesion | (Note 8) | A | B | A | D | C | B | D | C | C |
| | Finishing Appearance | Visual Observation | A | A | A | A | A | D | D | D | D |
| | (Note 9) | Gloss | A | A | A | A | A | D | C | D | D |
| | Scratch Resistance | (Note 10) | A | B | A | B | B | D | C | C | D |
| | Weather Resistance | Appearance | A | B | A | C | C | B | D | D | D |
| | (Note 11) | Adhesion | A | A | A | D | D | A | D | D | D |
| | Acid Resistance | (Note 12) | A | A | A | B | B | B | B | B | B |

| | | | | | | | | | |
|---|---|---|---|---|---|---|---|---|---|
| Comprehensive Evaluation | A | B | A | D | D | D | D | D | D |

TABLE 7

| | | | Example | | | | | | | | | |
|---|---|---|---|---|---|---|---|---|---|---|---|---|
| | | | 59 | 60 | 61 | 62 | 63 | 64 | 65 | 66 | 67 | 68 |
| Substrate | | | A | A | A | A | A | A | A | A | A | A |
| Base Coating Composition No. | | | 1 | 1 | 1 | 1 | 1 | 1 | 1 | 1 | 1 | 1 |
| Preheat | | | Yes | Yes | Yes | Yes | Yes | Yes | Yes | Yes | Yes | Yes |
| Coating Composition (Clear Coating Composition) No. | | | 19 | 20 | 21 | 22 | 23 | 24 | 25 | 26 | 27 | 28 |
| Evaluation Items | Solvent Resistance | (Note 7) | A | A | A | A | A | A | A | A | A | A |
| | Adhesion | (Note 8) | A | A | A | A | A | A | A | B | B | B |
| | Finishing Appearance | Visual Observation | A | A | A | A | B | A | A | A | A | A |
| | (Note 9) | Gloss | A | A | A | A | B | A | A | A | A | A |
| | Scratch Resistance | (Note 10) | B | A | A | A | B | B | B | A | A | A |
| | Weather Resistance | Appearance | B | A | A | A | B | B | B | A | A | A |
| | (Note 11) | Adhesion | A | A | A | A | A | A | A | A | A | A |
| | Acid Resistance | (Note 12) | B | B | A | A | A | A | A | A | A | A |
| | Comprehensive Evaluation | | B | B | A | A | B | B | B | B | B | B |
| | | | Example | | | | Comparative Example | | | | | |
| | | | 69 | 70 | 71 | 72 | 25 | 26 | 27 | 28 | 29 | 30 |
| Substrate | | | A | A | A | A | A | A | A | A | A | A |
| Base Coating Composition No. | | | 1 | 1 | 1 | 2 | 1 | 1 | 1 | 1 | 1 | 1 |
| Preheat | | | Yes | Yes | Yes | Yes | Yes | Yes | Yes | Yes | Yes | Yes |
| Coating Composition (Clear Coating Composition) No. | | | 29 | 30 | 31 | 22 | 32 | 33 | 34 | 35 | 36 | 37 |
| Evaluation Items | Solvent Resistance | (Note 7) | A | A | A | A | B | B | B | B | B | B |
| | Adhesion | (Note 8) | A | B | A | A | D | C | B | D | C | C |
| | Finishing Appearance | Visual Observation | A | A | A | A | A | A | D | D | D | D |
| | (Note 9) | Gloss | A | A | A | A | A | A | D | C | D | D |
| | Scratch Resistance | (Note 10) | A | A | A | A | B | B | D | C | C | D |
| | Weather Resistance | Appearance | A | A | A | A | C | C | B | D | D | D |
| | (Note 11) | Adhesion | A | A | A | A | D | D | A | D | D | D |
| | Acid Resistance | (Note 12) | A | A | A | A | B | B | B | B | B | B |

| | | | | | | | | | | |
|---|---|---|---|---|---|---|---|---|---|---|
| Comprehensive Evaluation | A | B | A | A | D | D | D | D | D | D |

TABLE 8

| | | | Example | | | | | | | | | | | | |
|---|---|---|---|---|---|---|---|---|---|---|---|---|---|---|---|
| | | | 73 | 74 | 75 | 76 | 77 | 78 | 79 | 80 | 81 | 82 | 83 | 84 | 85 |
| Substrate | | | A | A | A | A | A | A | A | A | A | A | A | A | A |
| Base Coating Composition No. | | | 1 | 1 | 1 | 1 | 1 | 1 | 1 | 1 | 1 | 1 | 1 | 1 | 1 |
| Preheat | | | Yes | Yes | Yes | Yes | Yes | Yes | Yes | Yes | Yes | Yes | Yes | Yes | Yes |
| Coating Composition (Clear Coating Composition) No. | | | 38 | 39 | 40 | 41 | 42 | 43 | 44 | 45 | 46 | 47 | 48 | 49 | 50 |
| Evaluation Items | Solvent Resistance | (Note 7) | A | A | A | A | A | A | A | A | A | A | A | A | A |
| | Adhesion | (Note 8) | A | A | A | A | A | A | A | B | B | B | A | A | A |
| | Finishing Appearance | Visual | A | A | A | A | B | A | A | A | A | A | B | B | A |
| | | Observation | | | | | | | | | | | | | |
| | (Note 9) | Gloss | A | A | A | A | B | A | A | A | A | A | B | B | A |
| | Scratch Resistance | (Note 10) | A | A | A | A | A | A | A | A | A | A | A | A | A |
| | Weather Resistance | Appearance | B | A | A | A | B | B | B | A | A | A | A | A | A |
| | (Note 11) | Adhesion | A | A | A | A | A | A | A | A | A | A | A | A | A |
| | Acid Resistance | (Note 12) | B | B | A | A | A | A | A | A | A | A | A | B | A |

| | | | | | | | | | | | | | |
|---|---|---|---|---|---|---|---|---|---|---|---|---|---|
| Comprehensive Evaluation | B | B | A | A | B | B | B | B | B | B | B | B | A |

TABLE 9
(continued from Table 8)

| | | | Example | | | | | | | |
|---|---|---|---|---|---|---|---|---|---|---|
| | | | 86 | 87 | 88 | 89 | 90 | 91 | 92 | 93 |
| Substrate | | | A | A | A | A | A | A | A | A |
| Base Coating Composition No. | | | 1 | 1 | 1 | 1 | 1 | 1 | 1 | 2 |
| Preheat | | | Yes | Yes | Yes | Yes | Yes | Yes | Yes | Yes |
| Coating Composition (Clear Coating Composition) No. | | | 51 | 52 | 53 | 54 | 55 | 56 | 57 | 41 |
| Evaluation Items | Solvent Resistance | (Note 7) | A | A | A | A | A | A | A | A |
| | Adhesion | (Note 8) | A | A | A | A | A | A | A | A |
| | Finishing Appearance | Visual Observation | A | A | A | A | A | A | A | A |
| | (Note 9) | Gloss | A | A | A | A | A | A | A | A |
| | Scratch Resistance | (Note 10) | B | A | A | A | A | A | A | A |
| | Weather Resistance | Appearance | A | A | A | A | A | B | A | A |
| | (Note 11) | Adhesion | A | A | A | A | A | A | A | A |
| | Acid Resistance | (Note 12) | A | A | A | A | A | A | A | A |
| | Comprehensive Evaluation | | B | A | A | A | A | B | A | A |
| | | | Example | | Comparative Example | | | | | |
| | | | 94 | 95 | 31 | 32 | 33 | 34 | 35 | 36 |
| Substrate | | | A | A | A | A | A | A | A | A |
| Base Coating Composition No. | | | 1 | 1 | 1 | 1 | 1 | 1 | 1 | 1 |
| Preheat | | | Yes | Yes | Yes | Yes | Yes | Yes | Yes | Yes |
| Coating Composition (Clear Coating Composition) No. | | | 57 | 57 | 58 | 59 | 60 | 61 | 62 | 63 |
| Evaluation Items | Solvent Resistance | (Note 7) | A | A | B | B | B | B | B | B |
| | Adhesion | (Note 8) | A | A | D | C | B | D | C | C |
| | Finishing Appearance | Visual Observation | A | A | A | A | D | D | D | D |
| | (Note 9) | Gloss | A | A | A | A | D | C | D | D |
| | Scratch Resistance | (Note 10) | A | A | B | B | D | C | C | D |
| | Weather Resistance | Appearance | A | A | C | C | B | D | D | D |
| | (Note 11) | Adhesion | A | A | D | D | A | D | D | D |
| | Acid Resistance | (Note 12) | A | A | B | B | B | B | B | B |

| | | | | | | | | |
|---|---|---|---|---|---|---|---|---|
| Comprehensive Evaluation | A | A | D | D | D | D | D | D |

### Consideration Results of Substrates B to D

### Example 96

“Soflex #420 silver” (produced by Kansai Paint Co., Ltd., trade name, a polyester urethane-based one-component organic solvent-based metallic coating composition) was applied as a base coating composition to the substrate B to a dry film thickness of 15 μm by electrostatic coating, and setting was performed at ordinary temperature for 3 minutes.

The coating composition No. 57 obtained in Production Example 45 was then applied thereto as a clear coating composition to a dry film thickness of 20 μm by air spray coating. Thereafter, the coated substrate was subjected to preheating (preliminary heating) at 50° C. for 3 minutes, and then irradiated with an active energy ray at a dose of 1,500 mJ/cm² with an ultra-high-pressure mercury lamp. Thereafter, the resulting substrate was dried at 90° C. for 10 minutes, thereby obtaining a test panel.

### Example 97

“Soflex #420 silver” (produced by Kansai Paint Co., Ltd., trade name, a polyester urethane-based one-component organic solvent-based metallic coating composition) was applied as a base coating composition to the substrate B to a dry film thickness of 15 μm by electrostatic coating, and preheating (preliminary heating) was performed at 80° C. for 3 minutes. Other than these steps, the same procedure was performed as in Example 96 to obtain a test panel.

### Example 98

The base coating composition No. 1 obtained in Production Example 24 was applied to the substrate B to a dry film thickness of 15 μm by electrostatic coating, and preheating (preliminary heating) was performed at 80° C. for 3 minutes. Other than these steps, the same procedure was performed as in Example 96 to obtain a test panel.

### Example 99

“Soflex #420 silver” (produced by Kansai Paint Co., Ltd., trade name, a polyester urethane-based one-component organic solvent-based metallic coating composition) was applied as a base coating composition to the substrate C to a dry film thickness of 15 μm by electrostatic coating, and setting was performed at ordinary temperature for 3 minutes.

Other than these steps, the same procedure was performed as in Example 96 to obtain a test panel.

### Example 100

“Soflex #420 silver” (produced by Kansai Paint Co., Ltd., trade name, a polyester urethane-based one-component organic solvent-based metallic coating composition) was applied as a base coating composition to the substrate C to a dry film thickness of 15 μm by electrostatic coating, and preheating (preliminary heating) was performed at 80° C. for 3 minutes. Other than these steps, the same procedure was performed as in Example 96 to obtain a test panel.

### Example 101

The base coating composition No. 1 obtained in Production Example 24 was applied to the substrate C to a dry film thickness of 15 μm by electrostatic coating, and preheating (preliminary heating) was performed at 80° C. for 3 minutes. Other than these steps, the same procedure was performed as in Example 96 to obtain a test panel.

### Example 102

“Soflex #420 silver” (produced by Kansai Paint Co., Ltd., trade name, a polyester urethane-based one-component organic solvent-based metallic coating composition) was applied as a base coating composition to the substrate D to a dry film thickness of 15 μm by electrostatic coating, and setting was performed at ordinary temperature for 3 minutes. Other than these steps, the same procedure was performed as in Example 96 to obtain a test panel.

### Example 103

“Soflex #420 silver” (produced by Kansai Paint Co., Ltd., trade name, a polyester urethane-based one-component organic solvent-based metallic coating composition) was applied as a base coating composition to the substrate D to a dry film thickness of 15 μm by electrostatic coating, and preheating (preliminary heating) was performed at 80° C. for 3 minutes. Other than these steps, the same procedure was performed as in Example 96 to obtain a test panel.

### Example 104

The base coating composition No. 1 obtained in Production Example 24 was applied to the substrate D to a dry film thickness of 15 μm by electrostatic coating, and preheating (preliminary heating) was performed at 80° C. for 3 minutes. Other than these steps, the same procedure was performed as in Example 96 to obtain a test panel.

Table 10 shows the coating compositions used in Examples 96 to 104 and the test results.

TABLE 10

| | | | Example | | | | | | | | |
|---|---|---|---|---|---|---|---|---|---|---|---|
| | | | 96 | 97 | 98 | 99 | 100 | 101 | 102 | 103 | 104 |
| Substrate | | | B | B | B | C | C | C | D | D | D |
| | | Preheating of | No | No | No | No | No | No | Yes | Yes | Yes |
| | | Primer Coating | | | | | | | | | |
| | | Composition | | | | | | | | | |
| | | Setting Time (min.) | 3 | 3 | 3 | 5 | 5 | 5 | 3 | 3 | 3 |
| Base Coating Composition | | | Soflex | Soflex | No. 1 | Soflex | Soflex | No. 1 | Soflex | Soflex | No. 1 |
| | | | #420 | #420 | | #420 | #420 | | #420 | #420 | |
| | | | Silver | Silver | | Silver | Silver | | Silver | Silver | |
| Preheating of Base Coating Composition | | | No | Yes | Yes | No | Yes | Yes | No | Yes | Yes |
| Coating Compostion (Clear Coating Composition) No. | | | 57 | 57 | 57 | 57 | 57 | 57 | 57 | 57 | 57 |
| Evaluation | Solvent Resistance | (Note 7) | A | A | A | A | A | A | A | A | A |
| Items | Adhesion | (Note 8) | A | A | A | A | A | A | A | A | A |
| | Finishing Appearance | Visual Observation | A | A | A | B | B | B | A | A | A |
| | (Note 9) | Gloss | A | A | A | A | A | A | A | A | A |
| | Scratch Resistance | (Note 10) | A | A | A | A | A | A | A | A | A |
| | Weather Resistance | Appearance | A | A | A | A | A | A | A | A | A |
| | (Note 11) | Adhesion | A | A | A | A | A | A | A | A | A |
| | Acid Resistance | (Note 12) | A | A | A | A | A | A | A | A | A |
| | Number of Heating Steps | (Note 13) | 2 | 3 | 3 | 2 | 3 | 3 | 3 | 4 | 4 |

| | | | | | | | | | |
|---|---|---|---|---|---|---|---|---|---|
| Comprehensive Evaluation | A | A | A | B | B | B | A | A | A |

### Test Method 2

(Note 7) Solvent resistance: the test and evaluation were performed in the same manner as described in the “Solvent resistance” in “Test Method 1” above.
(Note 8) Adhesion: a grid of 100 squares (2 mm×2 mm) was formed on the coating surface of each test panel according to JIS K 5600-5-6 (1990), and an adhesive tape was applied to the grid portion. After the adhesive tape was abruptly peeled off, the number of grid squares remaining on the surface of the coating film was evaluated.
A: Remaining number/Total number=100 squares/100 squares, with no edge chipping.
B: Remaining number/Total number=100 squares/100 squares, with edge chipping observed.
C: Remaining number/Total number=99 to 90 squares/100 squares.
D: Remaining number/Total number=89 squares or less/100 squares.
(Note 9) Finishing appearance: the finishing appearance of each test panel was evaluated by the following visual evaluation and gloss measurement.

### Visual Evaluation

Each test panel was visually observed, and the degree of occurrence of metallic mottling was evaluated according to the following criteria:

A: Substantially no metallic mottling was observed, and the coating film has an extremely excellent appearance.
B: A small amount of metallic mottling was observed, but the coated film has an excellent appearance.
C: Metallic mottling was observed, and the coating film has a slightly poor appearance.
D: A considerable amount of metallic mottling was observed, and the coating film has a poor appearance.

### Gloss Measurement

The glossiness of each coating surface was measured based on the specular gloss (60 degrees) according to JIS K5600-4-7 (1999). The measured glossiness was evaluated according to the following criteria:

A: Specular gloss of 90 or more.
B: Specular gloss of 70 or more, and less than 90.
C: Specular gloss of 50 or more, and less than 70.
D: Specular gloss of less than 50.
(Notes 10) Scratch resistance: the test and evaluation were performed in the same manner as described in the “Scratch resistance” in “Test Method 1” above.
(Note 11) Weather resistance: the tests and evaluations regarding the appearance and adhesion were performed in the same manner as described in the “Weather resistance” in “Test Method 1” above.
(Note 12) Acid resistance: the test and evaluation were performed in the same manner as described in the “Acid resistance” in “Test Method 1” above.
(Note 13) Number of heating steps: the total number of heating steps, i.e., the step of preheating an aqueous primer coating composition, the step of preheating a base coating composition, the step of preheating a clear coating composition, and the step of drying by heating a clear coating composition, was used as an index of energy-saving performance.

### Comprehensive Evaluation

In the field of coating of automobile bodies etc., to which the present invention pertains, it is important that the obtained coating films are excellent in all the properties of solvent resistance, adhesion, finishing appearance, scratch resistance, weather resistance, and acid resistance. Based on this, each coating composition was subjected to comprehensive evaluation in accordance with the following criteria:

A: The solvent resistance, adhesion, finishing appearance (visual observation), finishing appearance (gloss), scratch resistance, weather resistance (appearance), weather resistance (adhesion), and acid resistance are all A.
B: The eight items above are all A or B, and at least one item is B.
C: The eight items above are all A, B, or C, and at least one item is C.
D: The eight items above are all A, B, C, or D, and at least one item is D.

1. A coating composition comprising:
a radically polymerizable unsaturated group-containing compound (A); and
a hydroxyl-containing resin (B);
the compound (A) being obtained by reacting a caprolactone-modified hydroxyalkyl (meth)acrylate with a polyisocyanate compound, and having an isocyanate equivalent of 300 to 3,800.

2. The coating composition according to claim 1, further comprising a photopolymerization initiator (C).

3. The coating composition according to claim 1, wherein the hydroxyl-containing resin (B) is a hydroxyl-containing acrylic resin.

4. The coating composition according to claim 1, further comprising an isocyanate compound (D) other than the compound (A).

5. The coating composition according to claim 1, further comprising a radically polymerizable unsaturated group-containing compound (E) other than the compound (A).

6. The coating composition according to claim 1, wherein the compound (A) has a weight average molecular weight of 500 to 2,000.

7. The coating composition according to claim 1, wherein the hydroxyl-containing resin (B) has a glass transition temperature of 0° C. or more.

8. A coated article obtained by applying the coating composition according to claim 1.

9. A method for forming a multilayer coating film, comprising the steps of:
forming a base coating film by applying a base coating composition comprising an active hydrogen-containing resin and a color pigment to a substrate;
forming a clear coating film by applying the coating composition according to claim 1; and
performing active energy ray irradiation and heating.
